(19) United States
(12) Patent Application Publication
(10) Pub. No.: US 2013/0179259 A1
(43) Pub. Date: Jul. 11, 2013

(54) COMPUTER-IMPLEMENTED SYSTEM AND METHOD FOR TARGETING INVESTORS COMPATIBLE WITH A COMPANY

(71) Applicants: Jason M. LINDAUER, North Potomac, MD (US); Jeffrey Smith, Germantown, MD (US)

(72) Inventors: Jason M. LINDAUER, North Potomac, MD (US); Jeffrey Smith, Germantown, MD (US)

(73) Assignee: The NASDAQ OMX Group, Inc., New York, NY (US)

(21) Appl. No.: 13/345,207

(22) Filed: Jan. 6, 2012

(51) Int. Cl. G06Q 30/02

(52) U.S. Cl. 705/14.52

(57) ABSTRACT

A computer-implemented method, apparatus, and non-transitory, computer-readable product target potential investors for a company. A computer server obtains investment characteristics information associated with each of a first number of investors and determines asset characteristics information associated with a company interested in attracting investment. The server then analyzes the investment characteristics information associated with each of the first number of investors and the asset characteristics information associated with the company. The analysis includes determining a total compatibility score for each of the first number of investors that is based on a first quantitative fit parameter, a second total impact parameter, and a third quality rating parameter. A second smaller number of investors is identified from the first number of investors based on the total compatibility scores and then provided for the company to prioritize investment targeting efforts on investors having higher respective total compatibility scores.

### TECHNOLOGY OVERVIEW

The technology relates to computer-assisted targeting of potential investors.

### BACKGROUND

One significant investment statistic is that the institutional investment community in the U.S. collectively manages over $10 trillion in equity assets of public companies. This number is obviously even larger when expanded to private companies and to investors outside of the U.S. In light of this, companies and other entities need to take an active approach to attracting and obtaining investment from potential investors for current and future operation and/or expansion.

Traditional methods of mass marketing, calling large numbers of possible investors, and visiting investor sites and/or arranging meetings with key people associated with the investor are simply unmanageable given the huge numbers of companies and potential investors. In addition, it is often less worthwhile to attempt to match an investor with a company that is incompatible with the investor's stated or historical objectives. For example, a financial company would likely not want to expend time and resources targeting an investor that does not typically invest in or has a stated policy against investing in financial companies. Conversely, that same company would likely want to focus its marketing energies on a handful of investors with sufficient amounts of capital and a history of investing in financial companies. A problem then is how to efficiently and effectively target or match a compatible and desirable investor with a particular company where both investor and company have a high likelihood of desiring and being satisfied with the match.

Earlier attempts at creating a comprehensive online investor targeting tool have fallen short. For example, known comprehensive online investor targeting tools do not include qualitative firm characteristics in their tool. But the quality of a potential investor is important to determine priority and amount of time company executives should spend with the firm. Prior online investor targeting tools also do not provide adequate transparency into understanding the reasons behind a targeting result, e.g., a high or low investor-company compatibility score. An overall score does not explain how that score was determined or the relative importance of individual metrics used in determining that score. Another shortcoming of existing online investor targeting tools is they do not provide one score that easily identifies top targets or shareholders based on the three criteria: quantitative fit, buying power or impact, and investor quality. This shortcoming makes the screening process longer and more iterative as users must screen potential investors using multiple criteria in order to achieve the desired result. What is needed is one all-encompassing score based on those three criteria that enables users to easily segment top-ranked investor targets for a particular company from a lower ranked investors based on multiple criteria.

Existing online investor targeting tools also do not provide a visual solution to identify regions, states, countries, and/or metro areas that are the highest priority for a company to travel to and conduct meetings with promising investors. What is needed is an online investor targeting tool with an integrated “roadshow planning” capability that facilitates planning, set up, and tracking of meetings with promising investors.

### SUMMARY

A first aspect of the technology relates to a computer-implemented method for targeting potential investors for a company. A computer server obtains investment characteristics information associated with each of a first number of investors and determines asset characteristics information associated with a company interested in attracting investment. The computer analyzes the investment characteristics information associated with each of the first number of investors and the asset characteristics information associated with the company. The analysis includes determining a total compatibility score for each of the first number of investors that is based on: a first quantitative fit parameter reflecting a degree of compatibility between the investment characteristics information associated with each of the first number of investors with the asset characteristics information associated with the company that is based on quantitative metrics, a second total impact parameter reflecting a monetary investment potential in the company for each of the first number of investors, and a third quality rating parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history. A second smaller number of investors is then identified from the first number of investors based on the total compatibility scores, and the second smaller number of investors is provided for the company to prioritize investment targeting efforts on investors having higher respective total compatibility scores.

In one non-limiting example embodiment, the first quantitative fit parameter is determined based on both a mean deviation and a standard deviation of each of multiple investor holding valuation metrics for a portfolio of holdings associated with each investor. The standard deviation also weights a relative importance of each investor holding valuation metric for each of the first number of investors. If one of the investor holding valuation metrics is dividend yield, then the dividend yield modeled as a truncated symmetric statistical distribution is converted to a non-truncated symmetric statistical distribution.

In one non-limiting application in this example embodiment, one of the investor holding valuation metrics can include a sector-based holding valuation metric, where each sector-based holding is modeled as a multinomial distribution.

The analysis in this example embodiment includes calculating a statistical profile for each of the first number of investors based on the mean deviation and the standard deviation of the multiple investor holding valuation metrics associated with each investor, the dividend yield modeled as a truncated symmetric statistical distribution metric, and sector-based holdings each modeled as a multinomial distribution. The truncated symmetric statistical distribution metric may be transformed into a statistically symmetric distribution metric.

The investor holding valuation metrics for a portfolio of holdings associated with each investor may include one or more of the following factors: market capitalization, dividend yield, price to book value, forecast 2-year sales growth, forecast price to earnings ratio, forecast enterprise value (EV)/earnings before interest, taxes, depreciation, and amortization (EBITDA), return on equity (ROE), market beta, net debt/total capital, forecast long-term earnings growth, free cash flow yield, net buyback yield, and sector/industry.

In another non-limiting example embodiment, the total compatibility score is determined for each of the first number of investors using one or both of (1) a buying assessment based on a current amount of investment in the company by each of the investors and an amount that each investor can purchase in the company in addition to what that investor may already own or (2) a selling assessment assessing an amount that each investor is over-weighted in investment in the company as compared to an estimated fully-weighted investment in the company.

The third quality rating parameter may also based on one or more of the following additional investor attributes: an investment type including one of an investment advisor, a hedge fund advisor, a venture capitalist, a private investment entity, and an arbitrage manager; an investment orientation including active investor, passive investor, or quantitative investor; and investment turnover.

Preferably, but not necessarily, each of the first, second, and third parameters is weighted and combined to generate the total compatibility score for each of the first number of investors.

In a non-limiting example embodiment, the investment characteristics information includes current investment holdings in each investor's investment portfolio and is obtained from public disclosures made by each investor. The obtaining step includes filtering the current investment holdings in each investor's investment portfolio investment characteristics information associated with each of a first number of investors, and the determining step includes transforming holding valuation metrics to exhibit a symmetric statistical distribution.

The step of providing the second number of investors to the company may include for example providing a display of multiple valuation metrics for each of the second number of investors in a single chart relative to the weighted average of all of the first number of investors.

In a non-limiting example embodiment, the step of providing the second number of investors to the company includes providing a display map of geographic regions associated with the second number of investors having higher respective total compatibility scores to assist a company representative in travel planning for face-to-face meetings with each of the second number of investors. The display map of geographic regions permits a viewer to select and highlight individual investor locations on the map to create a travel plan for the company representative to visit the higher priority investors having higher respective total compatibility scores. The display map of geographic regions further permits a viewer to select and highlight individual investor locations on the map having predetermined minimum amount of holding assets.

A first aspect of the technology relates to a computer server for targeting potential investors for a company that includes a memory configured to store investment characteristics information associated with each of a first number of investors and asset characteristics information associated with a company interested in attracting investment and processing circuitry capable of communicating with the memory. The processing circuitry is configured to analyze the investment characteristics information associated with each of the first number of investors and the asset characteristics information associated with the company and determine a total compatibility score for each of the first number of investors that is based on: a first quantitative fit parameter reflecting a degree of compatibility between the investment characteristics information associated with each of the first number of investors with the asset characteristics information associated with the company that is based on quantitative metrics, a second total impact parameter reflecting a monetary investment potential in the company for each of the first number of investors, and a third quality rating parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history. The processing circuitry is also configured to identify a second smaller number of investors from the first number of investors based on the total compatibility scores and provide the second smaller number of investors for the company to prioritize investment targeting efforts on investors having higher respective total compatibility scores.

According to a third aspect, a non-transitory computer-readable storage medium having computer readable code embodied therein for executing the method described above for use in targeting potential investors for a company.

### BRIEF DESCRIPTION OF THE DRAWINGS

FIG. 1 illustrates a non-limiting example function block diagram showing a computer server-based system that may be used to implement the system and method for targeting investors compatible with a company;

FIG. 2 illustrates conceptually three parameters that are used to calculate a total compatibility score for each of a number of investors;

FIG. 3 illustrates a flowchart diagram of example procedures for computing a total compatibility score based on the three parameters;

FIG. 4 is a flowchart diagram of example procedures for generating the three parameters;

FIG. 5 is a flowchart diagram illustrating example procedures for an initial processing of portfolio holdings of investors;

FIG. 6 is a flowchart diagram illustrating example procedures for analyzing the portfolio holdings of investors to determine multiple valuation metrics for those holdings;

FIG. 7 is a flowchart diagram illustrating non-limiting example procedures for generating a statistical profile of potential investors;

FIG. 8 is a flowchart diagram illustrating non-limiting example procedures for calculating the first quantitative fit parameter;

FIG. 9 is a flowchart diagram illustrating non-limiting example procedures for computing the second total impact parameter;

FIG. 10 show example charts illustrating the first quantitative fit (QuantFit or QFit) parameter and the second total impact parameter;

FIG. 11 is a flowchart diagram illustrating non-limiting example procedures for determining the third quality rating parameter;

FIG. 12 is a diagram illustrating non-limiting example procedures for determining the three parameters and determining a total compatibility score for each of many investors;

FIG. 13A is a graph showing a portfolio fit chart that illustrates how compatible target investor's overall portfolio with respect to a given valuation metric;

FIG. 13B shows a non-limiting example illustrating a portfolio fit graphic with six valuation metrics of relative importance;

FIG. 14 is a flowchart diagram illustrating non-limiting example procedures for a graphical mapping tool that may be used to develop a road show itinerary based on the various compatibility criteria for various investors having total compatibility scores; and

FIGS. 15-22 are non-limiting example graphical mapping screenshots relating to the roadshow itinerary planning.

### DETAILED DESCRIPTION

In the following description, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted as tables below, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred. A description of a process is a description of a computer-implemented apparatus for performing the process. The apparatus that performs the process can include, e.g., a processor and those input devices and output devices that are appropriate to perform the process.

Various forms of computer readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards, or protocols; and/or (iv) encrypted to ensure privacy or prevent fraud in any of a variety of ways well known in the art.

The technology in this case may be used in any type of investor targeting, investor “roadshow” planning, meeting organization and prioritization, and/or any type of investor access. The technology enables a company to prioritize among a very large number of potential investors based on three main criteria: (1) a quantitative fit parameter which identifies investors having a highest compatibility with a company's characteristics, e.g., that company's stock fundamentals, (2) an impact parameter that determines a potential investment amount the investor can buy, e.g., if the investor is a fund, an amount of shares that fund can buy to hold an above-average weight in that stock in its portfolio, and (3) a quality rating parameter which provides a desirability rating that helps prioritize investors on a numerical scale, e.g., a 0-5 scale, based on an investor's investment tendencies and perhaps other qualitative factors.

The term “company” as used herein includes but is not limited to traditional businesses both public and private, investment banks, venture capital firms, private equity firms, non-governmental organizations, and charities. The term “investor” as used herein includes but is not limited to investment firms like financial brokerage firms, financial funds like mutual funds and hedge funds, venture capital firms, private equity firms, pension funds, sovereign wealth managers, insurance companies, investment advisors, foundations, endowments, investment bank asset managers, bank management division, and individual investors.

With this technology, companies, e.g., company representatives like CEOs, CFOs, and IROs, can prioritize their time, efforts, and other resources setting up and conducting communications with particular investors of interest. For example, company representatives can use the technology to maximize or at least improve their return on investment (ROI) with respect to meeting with investors during deal and non-deal roadshows, conventions, and the like. The technology also helps company representatives better understand investment drivers and other characteristics of each investor. Example drivers for a fund investor might be an identification of one or more valuation parameters that are most important to the fund manager and a determination of changes in the company's valuation or capital structure that might make the fund investor more or less compatible with the company. The technology can also be used for “scenario analysis.” If a company is contemplating issuing or terminating a dividend, for example, a computer-implemented modeling procedure may be used to predict a likelihood that an investor would sell the company's stock based on the change in valuation. Another way that a company can use the technology to identify and then take steps to reduce a “sell risk” of current actual investment in the company.

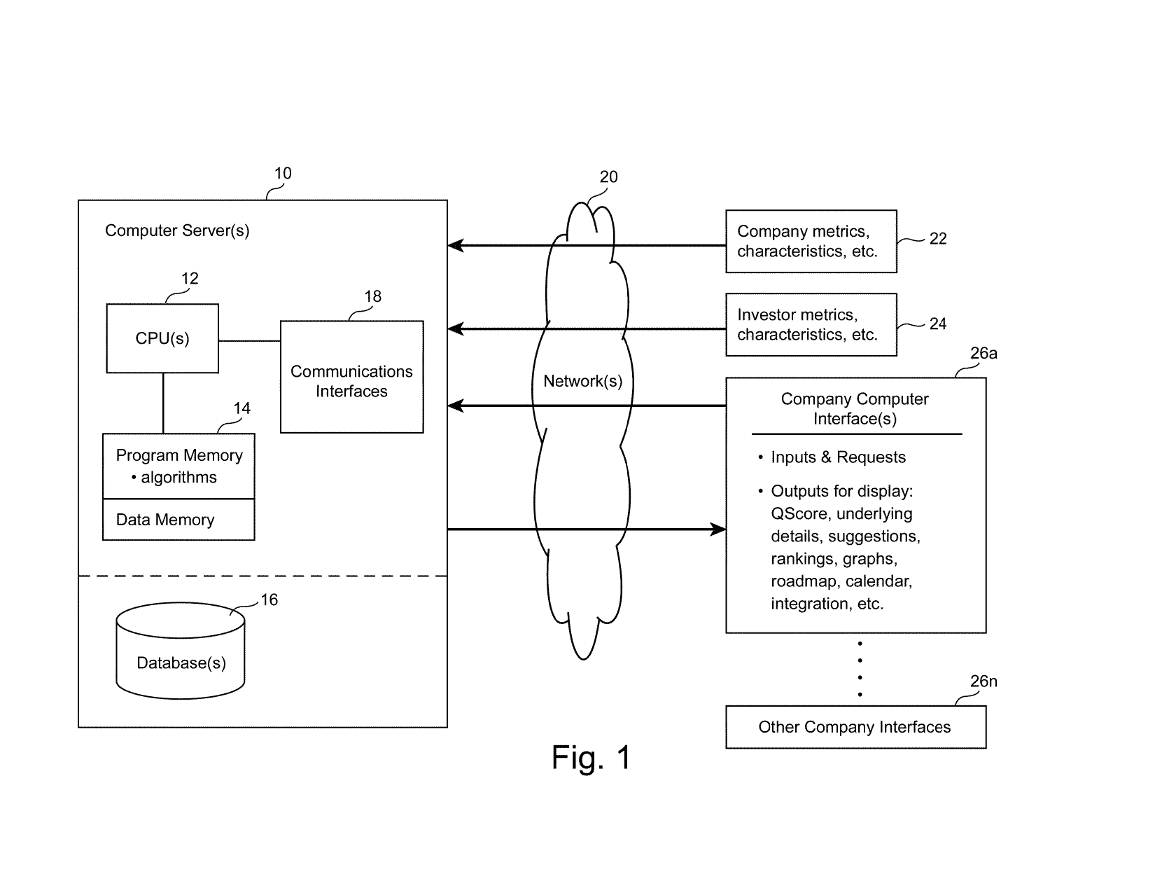

FIG. 1 illustrates a non-limiting example function block diagram showing a computer server-based system that may be used to implement the system and method for targeting investors compatible with a company. One or more computer-based servers 10 perform the functions described below and provide various services to client customer companies, e.g., subscribers to a compatible investor targeting service. The computer-based servers 10 include one or more central processing units (CPUs) 12 coupled to memory 14 and one or more communications interfaces 18. The memory 14 can be one or more memories which store data and computer instructions which when executed by the one or more CPUs 12 cause them to perform the algorithms and other functions necessary to provide the compatible investor targeting service. The computer-based servers 10 also have access to one or more databases 16 that store longer term information relating to a large number of investors and information relating to each customer company. The databases 16 may be located on site with the CPUs 12 or off-site.

The computer server 10 communicates via one or more communications networks 20 with company computers, investment information services, feeds, etc. Company metrics and characteristics 22 for use in determining investor compatibility may be provided by a third party data vendor (e.g., FactSet Research Systems) to the server 10 via a network communication. But any suitable method for providing such information may also be used. Investor metrics and characteristics 24 for use in determining investor compatibility with companies are obtained either directly from each investor, public sources of investor metrics and characteristics, or in one embodiment, from entities that provide such information as a service and update it with high frequency so that the information is fresh and current. Again, any suitable method for providing such information may be used. Any reasonable number of investors may be monitored, but the technology has the capacity to monitor tens of thousands of investors or even more.

Each user or customer of the targeting system shown in FIG. 1, i.e., customer companies looking for compatible investors, has one or more company computer interfaces 26, preferably computerized interfaces with graphical display capabilities, provide for communication with the server 10. For example, a company user sends a request with various inputs which are processed, as described below, to provide various targeted compatible investor information including for example a total compatibility score (QScore), metrics or characteristics underlying that score, along with suggestions, priority rankings, graphs, roadshow map suggestions for potential investor meetings, and calendar integration for such meetings, etc.

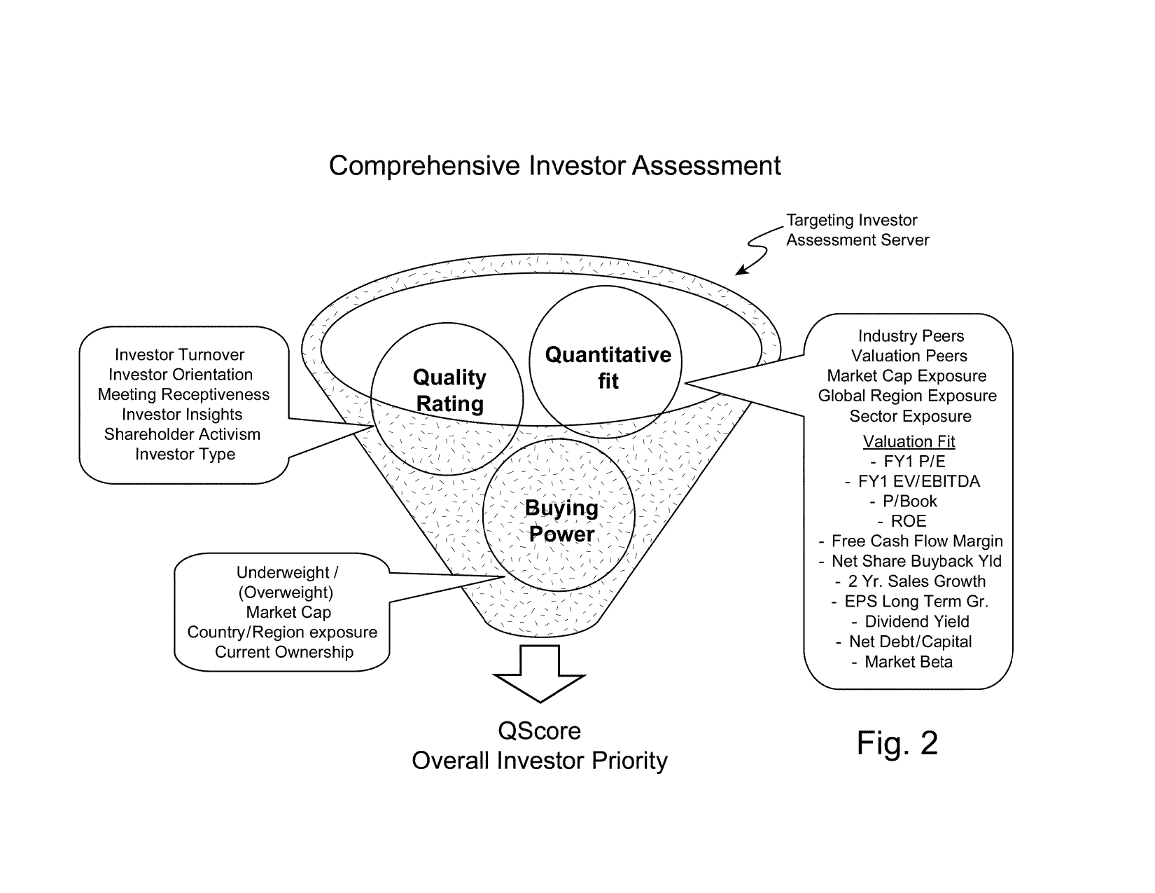

FIG. 2 is a diagram that illustrates conceptually using a funnel the bringing together of three distinct investor assessment parameters used to calculate a total compatibility score for each of a number of investors. The funnel represents the computer server 10 in FIG. 1 that provides the compatibility service to the company. A quantitative fit parameter reflects a degree of compatibility between investment characteristics information associated with each investor with the asset characteristics information associated with the company that is based on quantitative metrics like market capitalization, dividend yield, price to book value, forecast 2-year sales growth, forecast price to earnings ratio, forecast enterprise value (EV)/earnings before interest, taxes, depreciation, and amortization (EBITDA), return on equity (ROE), market beta, net debt/total capital, forecast long-term earnings growth, free cash flow yield, net buyback yield, and sector/industry. A total impact parameter, labeled as buying power in the figure, reflects a monetary investment potential in the company for each investor. The total impact parameter may take into account a buying assessment based on a current amount of investment in the company by each of the investors and an amount that each investor can purchase in the company in addition to what that investor may already own, a selling assessment assessing an amount that each investor is over-weighted in investment in the company as compared to an estimated fully-weighted investment in the company, and/or country/region exposure. The quality rating or rank parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history.

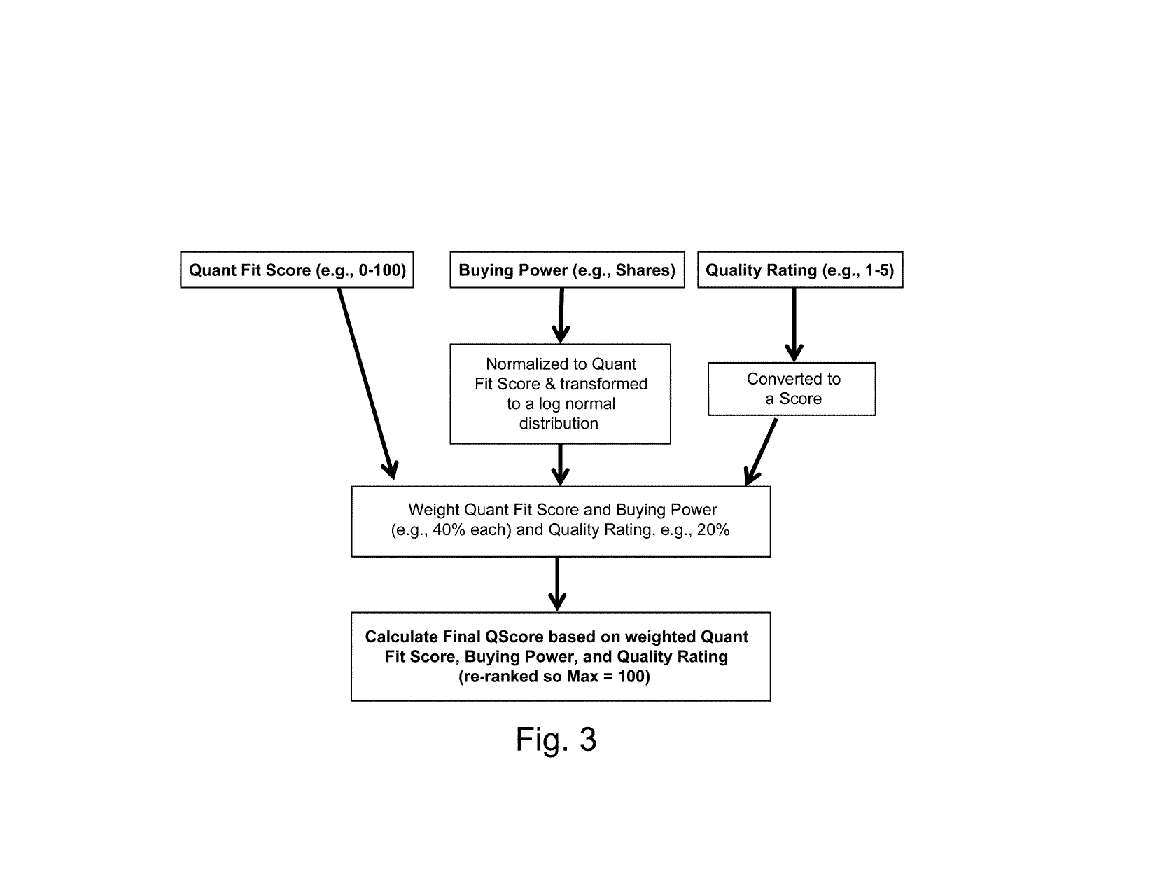

FIG. 3 illustrates a flowchart diagram of example procedures for computing a total compatibility score based on the three parameters. The “quant fit” can for example range from 0-100, the buying power can be for example number of shares, and quality rating can for example range from 1-5. In a non-limiting example embodiment, the buying power is normalized to the quant fit score and transformed to a log normal distribution and the quality rating is converted to a quant fit score so that the three parameters can be further processed on the same scale. Further, some sort of weighting may be applied to each parameter at this point depending on how much importance is desired to be attached to each parameter. In one non-limiting example the quant fit and buying power scores are weighted 40% each and the quality rating is weighted 20%. A single final QScore, e.g., ranging from 0-100, is calculated based on a combination of the weighted scores.

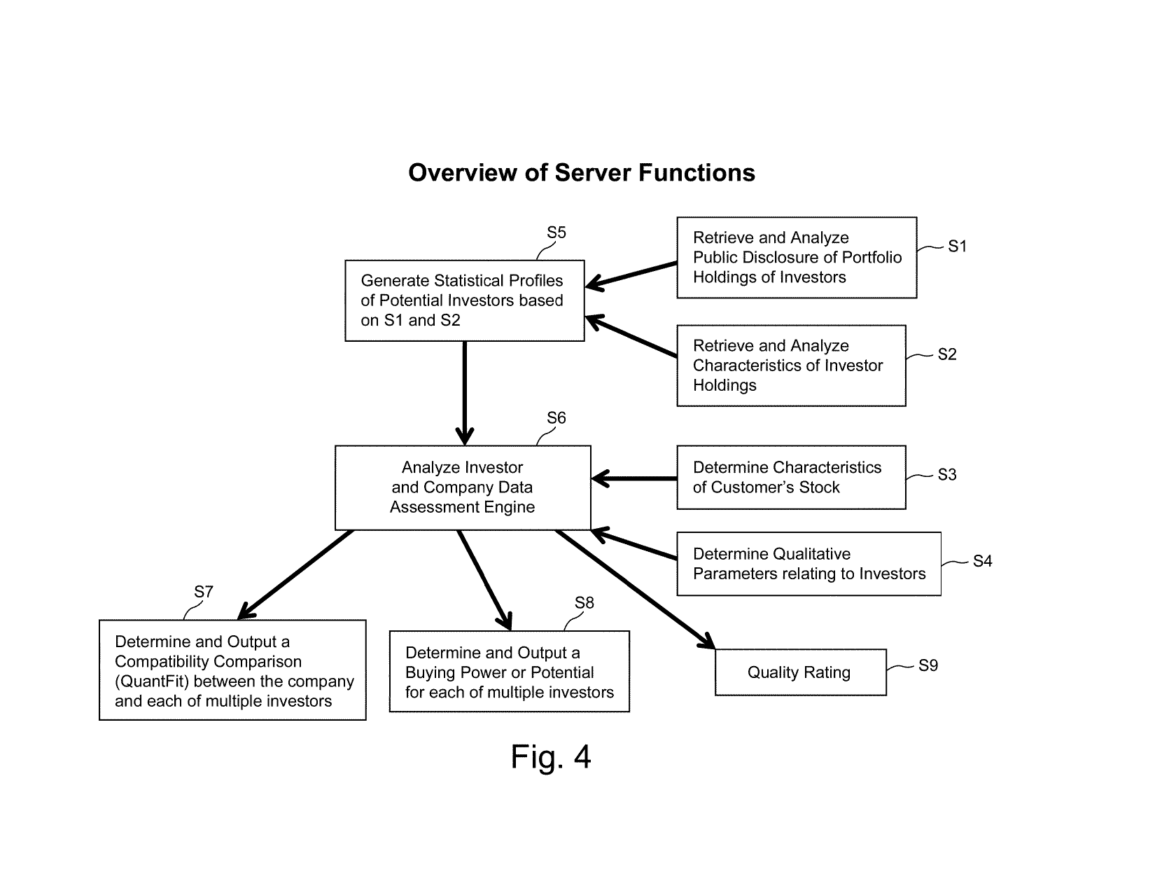

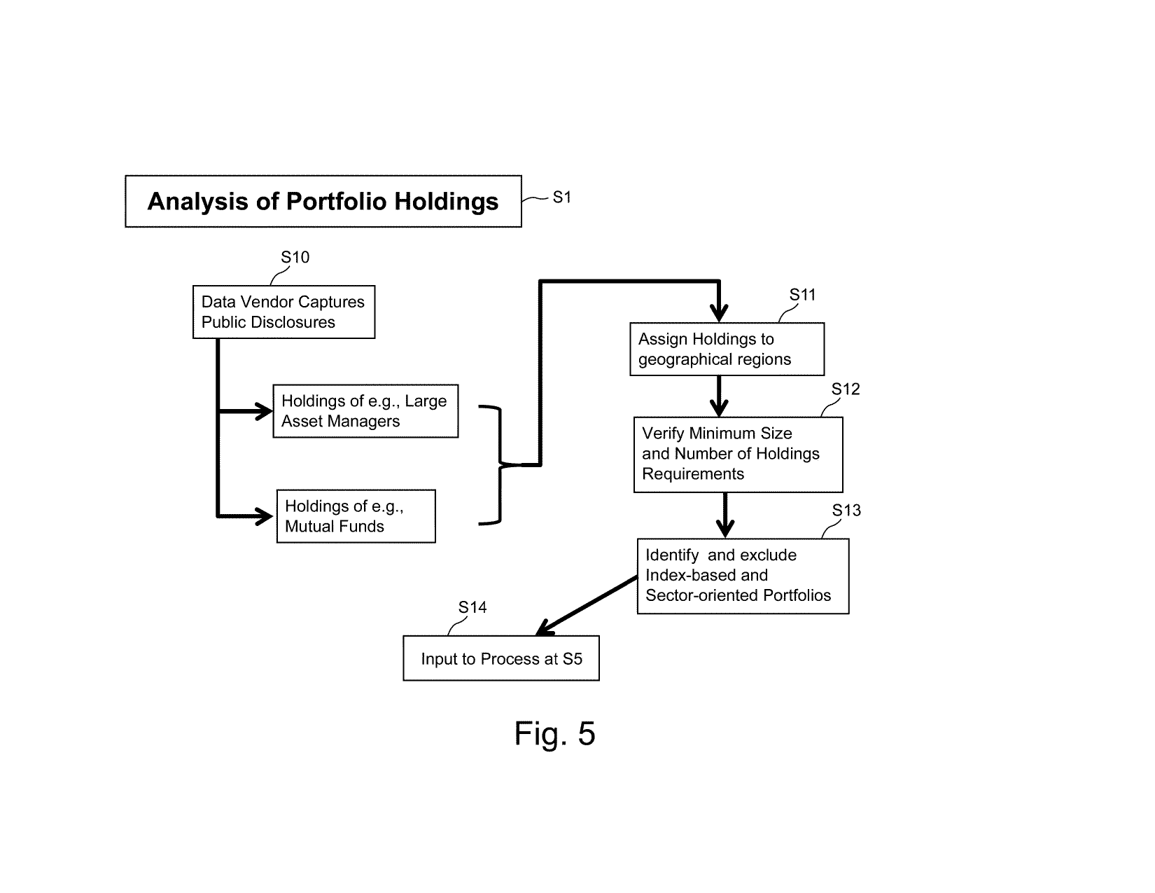

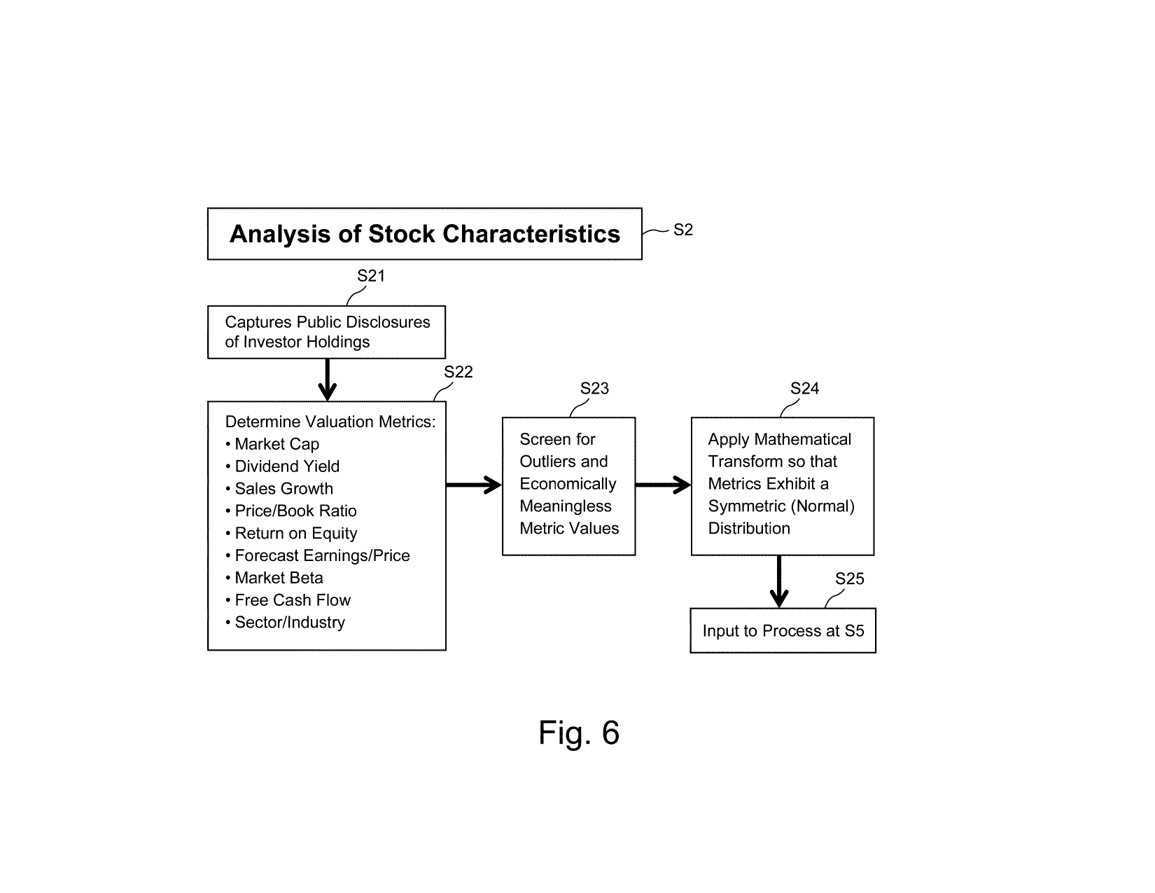

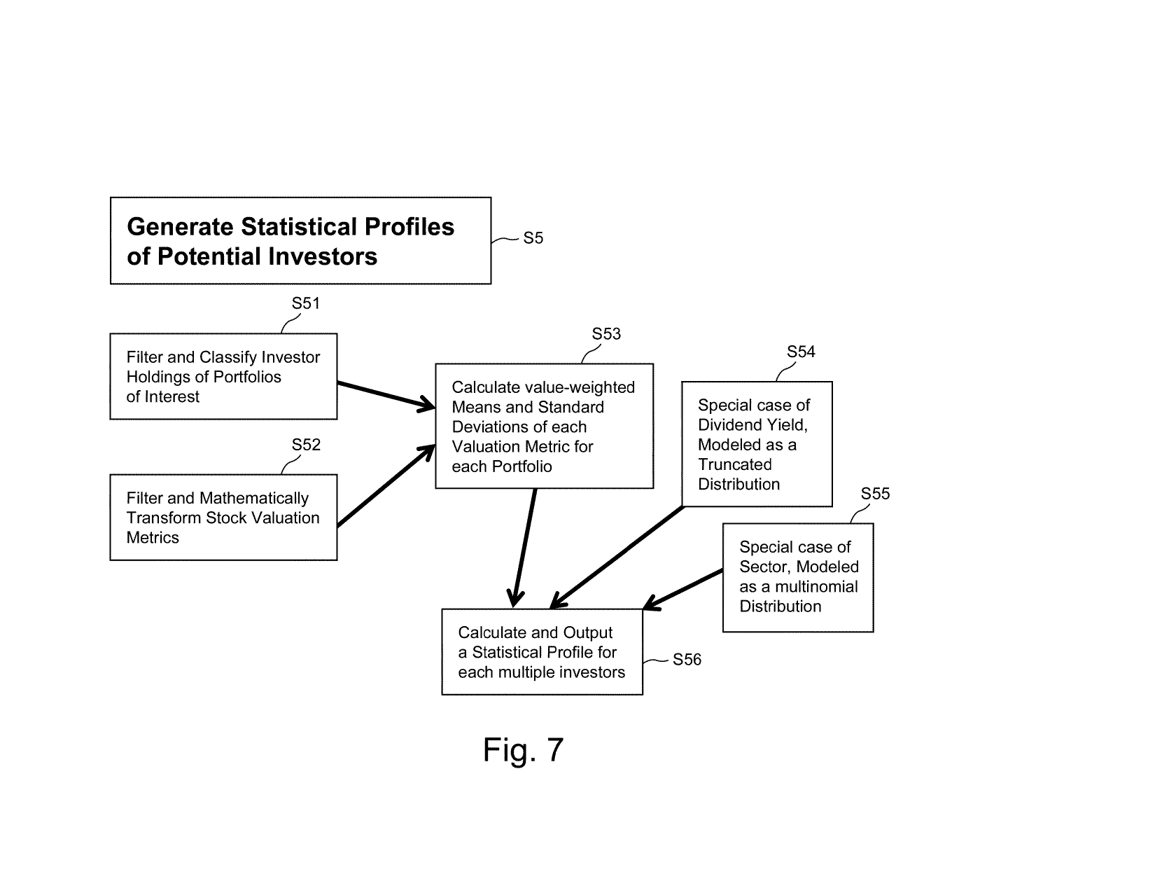

FIG. 4 is a flowchart diagram of example overall procedures showing how the server generates the three parameters. In step S1, the server retrieves and analyzes public disclosures of portfolio holdings of a large number of investors, e.g., tens of thousands of investors. An example implementation of this step is described in conjunction with FIG. 5. Portfolio holdings include for example any financial instrument like stocks, bonds, options, Exchange Traded Funds (ETF), futures, real estate interest trusts (REITs), or any other public investment. Example sources for such public investment disclosure information include SEC 13F & 13D/G filings, mutual fund semi-annual and annual reports and SEC N-30D filings, via a data collection process. The server in step S2 analyzes characteristics of the holdings, an example implementation of this step is described in conjunction with FIG. 6, and the information generated in steps S1 and S2 is used by the server in step S5 to generate statistical profiles of potential investors. An example implementation of step S5 is described in conjunction with FIG. 7. In step S6, an assessment engine in the server analyzes the investor profiles to compare them with characteristics of the customer company, e.g., that company's stock, provided in step S3. The analysis in the assessment engine also takes into account qualitative parameter information developed in step S4 for each investor to make the comparison more comprehensive. The assessment engine then determines and outputs a compatibility comparison quant fit score (step S7), buying power (step S8), and quality rating (step S7) for each investor relative to the customer company.

FIG. 5 is a flowchart diagram illustrating non-limiting example procedures for an initial processing of portfolio holdings of investors. A data vendor, e.g., a third party vendor like FactSet Research Systems, captures public disclosure data including investment holdings for a large number of investors like large asset managers, mutual funds, etc. The investment holdings may be assigned to geographic regions (step S11) so as to isolate preferences for a specific region (e.g., Asia, U.S., Western Europe, etc.). The server “engine” 10 receiving this holding data preferably filters out investors with holdings that do not meet a minimum size threshold and a minimum number of holdings threshold to reduce the amount of data that needs to be processed (step S12). In step S13, the server identifies and excludes index-based and sector-based holdings or portfolios, which do not provide strong indication of specific investor-company potential compatibility. The remaining information is then input to the server for processing at step S5 in FIG. 4.

FIG. 6A is a flowchart diagram illustrating example procedures for analyzing the portfolio holdings of investors to determine multiple valuation metrics for those holdings as indicated in step S2 in FIG. 4. The server 10 processes the captured public disclosure information (S21) to determine multiple valuation metrics (step S22) (see the example metrics listed in the figure) and screens for outliers and economically meaningless values (step S23). A mathematical transform is applied so that the metrics exhibit a normal or symmetric distribution (step S24), which allows characterization through of two parameters: the mean and the standard deviation. A valuation metric that roughly follows a normal distribution, or can be transformed to be a normal distribution, offers a number of advantages. One is that the distribution can be characterized using two parameters: the mean and the standard deviation. Further, under normality, the compatibility of a given stock with respect to the holdings of a portfolio can be quantitatively assessed using standard formulas associated with the normal distribution. Step S25 shows the transformed metrics being input for use in generating a statistical profile of potential investors as shown at step S5 in FIG. 4.

FIG. 7 is a flowchart diagram illustrating non-limiting example procedures for generating a statistical profile of potential investors. At steps S51 and S52, the server 10 receives the filtered and transformed data as per steps S14 and S25 in FIGS. 5 and 6 above. The server 10 then calculates value-weighted means and standard deviations of each valuation metrics for each portfolio (step S53). The valuation metric dividend yield may be handled as a special case and be modeled as a truncated distribution (step S54). Such an approach may be warranted due to the fact that many stocks pay no dividend, but for those that do pay a dividend, the distribution of dividend yield appears to follow the non-truncated portion of a Normal distribution. Likewise, a sector metric may be handled as a special case and be modeled as a multinomial distribution (step S55). This is useful where a portfolio manager's choice of holdings is tied to a discrete set of sectors or industries as opposed to some continuous metric such as market capitalization or P/E ratio. From the inputs provided by steps S53-S55, the server calculates and outputs a statistical profile for each of the potential investors (step S56).

The following describes one non-limiting, detailed, but still example methodology for generating a quant fit score for each of many investors following the general procedures in FIG. 7. The quant fit score measures the statistical similarity between the customer company's stock and the portfolio of a potential investor, using a set of commonly-used valuation metrics. In this example, two broad categories of investors are assumed of interest: portfolio managers of mutual funds and large institutional asset managers. These two categories are not mutually exclusive as many asset managers manage mutual funds. For both groups, standard business practices as well as securities laws of the relevant jurisdictions provide for public disclosure of current holdings of these portfolios. From this portfolio holding information, the “quant fit” score is calculated.

First, the holdings of the equity securities of all investor portfolios of interest are collected based upon the most recent public disclosures. Second, a set of valuation metrics is collected for the global universe of active equity securities. The current set of valuation metrics may include multiple variables: market capitalization, dividend yield, price to book value, forecast 2-year sales growth, forecast price to earnings ratio, forecast enterprise value (EV)/earnings before interest, taxes, depreciation, and amortization (EBITDA), return on equity (ROE), market beta, net debt/total capital, forecast long-term earnings growth, free cash flow yield, net buyback yield, and sector/industry. This set of metrics may be modified so as to better reflect the criteria used by portfolio managers in making investment decisions.

Next, the security valuation metrics are combined with the holdings data. Statistical means and standard deviations of the valuation metrics are calculated for the holdings of each mutual fund or asset manager. These statistics are weighted by the value of holdings as demonstrated now. Let the holdings of portfolio i in stock j (measured in shares) be represented as sᵢⱼ. Allowing the current stock price of j to be represented as pⱼ, the value of holdings is calculated as sᵢⱼ×pⱼ. Let v^{k}ⱼ represent the current value of valuation metric k for stock j. Then for portfolio i, the weighted mean and standard deviation of the k^{th} metric are given as:

$${μ}_{t}^{k} = \frac{{Σ}_{j} {w}_{ij} {v}_{j}^{k}}{{Σ}_{j} {w}_{ij}} \\$$

where wᵢⱼ is the value of the holding: sᵢⱼ×pⱼ. In the case of some valuation metrics, for example, market capitalization, using the raw data results in a skewed data set. As such, log transformations are preferably used to ensure symmetry in the distribution.

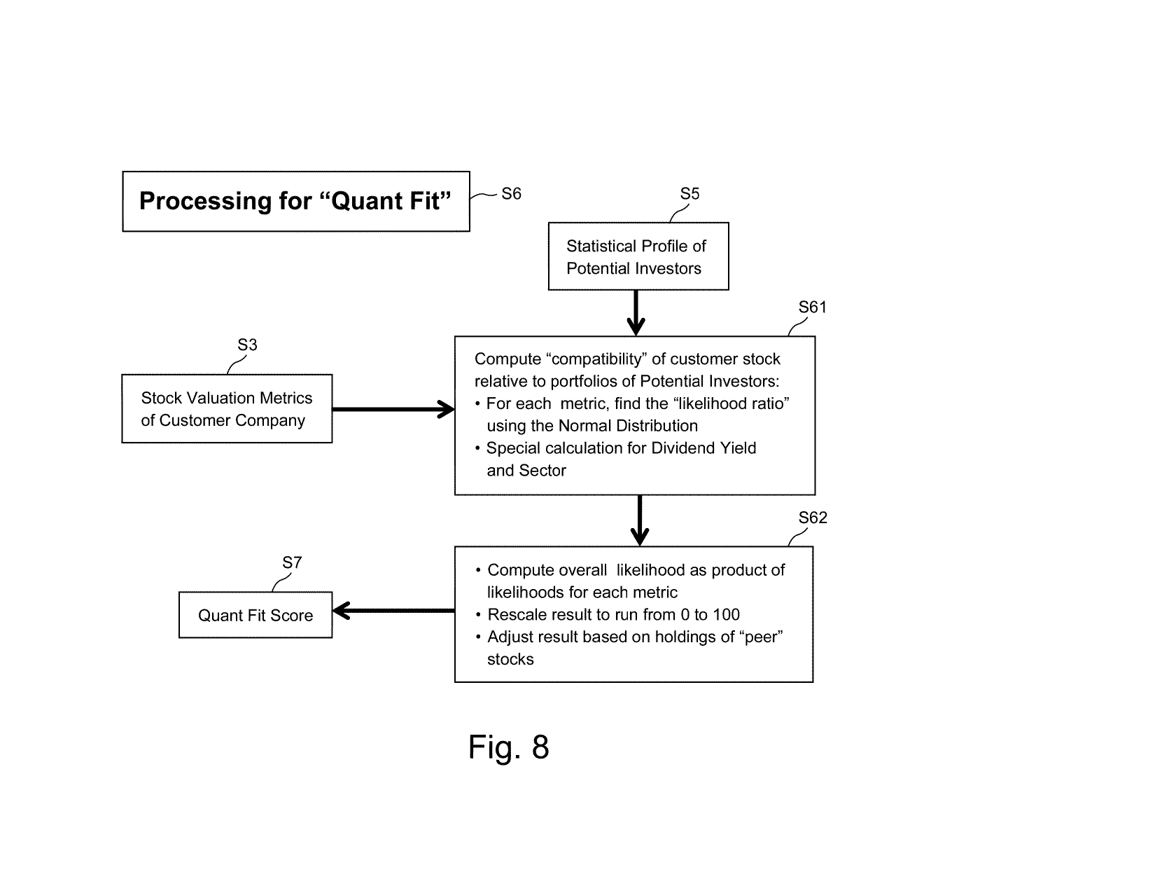

A “likelihood factor” is then computed for each portfolio and for each valuation metric with respect to the customer company's stock. See steps S61 and S62 in FIG. 8. This factor is calculated using the normal distribution in combination with the estimated mean and standard deviation. Let vₖ* represent the value of valuation metric k for the customer's stock. The likelihood factor for portfolio i, valuation metric k, is calculated according to the following formula:

$${LF}_{ik} = φ ( \text{?} )$$

$$\text{?} \text{indicates text missing or illegible when filed}$$

where φ( ) is the standard normal density function. The likelihood factor quantifies the compatibility of the customer company's stock to the portfolio. As the company stock's valuation metric approaches the portfolio mean, the likelihood factor increases. For a given difference between the company stock's valuation metric and the portfolio mean, the likelihood factor increases as the standard deviation decreases. Consequently, the standard deviation can be viewed as an empirical measure of the importance of that valuation metric to the portfolio manager. The lower the standard deviation, the more selective the manager is with respect to that metric.

The next step is to apply a modified version of the aforementioned procedure in the case of the dividend yield valuation metric. Many stocks held in portfolios pay no dividend, hence have dividend yield of zero. Further, for those stocks that do pay a dividend, the distribution of dividend yields is modeled as a “truncated Normal” distribution, with truncation at zero. A sample of stocks, some of which pay dividends and some do not, therefore results in a model for dividend yields generally termed a “censored Normal” model, with left censoring at zero. This model has two parameters, μ and σ, which can be estimated using a weighted Maximum Likelihood method, where the weights are the value of the holding. These parameters roughly correspond to the mean and standard deviation, but because of the censoring, they are not exactly the mean and standard deviation of the actual dividend yield.

The dividend yield likelihood factor for portfolio i is:

$${LF}_{i}^{DivYld} = \{ \begin{matrix}φ ( \frac{{DivYld}^{*} - {μ}_{i}^{DivYld}}{{σ}_{i}^{DivYld}} ) & when {DivYld}^{*} > 0 \\ Φ ( \frac{0 - {μ}_{i}^{DivYld}}{{σ}_{i}^{DivYld}} ) & when {DivYld}^{*} = 0\end{matrix}$$

where DivYld* is the dividend yield of the customer's stock, μᵢ^{DivYld} and σᵢ^{DivYld} are the estimated parameters for portfolio i from the censored normal model, φ( ) is the standard Normal density function, and Φ( ) is the standard Normal cumulative distribution function.

In addition to continuous valuation metrics, the model preferably generates a likelihood factor based on the industrial sector of the customer company stock. This factor may be evaluated in the model as the proportion of the value of holdings of the portfolio in the sector of the company's stock. For example, if the company stock is in the utilities sector, and a given mutual fund has 2% of its holdings (value weighted) in utilities companies, the sector likelihood factor is 0.02.

Accounting for the likelihood factors for all valuation metrics as well as sector, the overall likelihood score for the ith portfolio may be taken as the product of the factors for each of the k metrics:

LFᵢ=ΠₖLFᵢₖ

The actual level of the LFᵢ does not have an interpretation. Rather, it has meaning only when compared with the scores of other funds or managers. For interpretative convenience, it is useful to normalize the likelihood scores by dividing all scores by the maximum score observed over all funds or managers. The normalized likelihood score is defined as:

LFₜ^{norm}=LFᵢ/maxₜ(LFₜ)

The normalized likelihood score is a basic input to the quant fit score. The actual quant fit score is a mathematical transformation of the normalized likelihood score:

QFₜ=(LFₜ^{norm})^{0.1}×100.

This transformation results in a better prediction of the actual holdings of portfolios than the untransformed score. Moreover, a transformed quant fit score ranges between a high value of 100 and a low value of 0, thereby providing a score that is easy to use and interpret.

A final adjustment to the likelihood score may be made using an approach that is complementary to the method described above. This approach is based on the idea that if an investor already holds stocks that are similar to the company's stock, then that investor is likely an attractive target for investing in the company's stock. The approach uses two groups of peer stocks. The “industry peers” are defined as the 10 stocks whose industry, (e.g., as defined by a third party like FactSet described above), is the same as the company stock, and whose market capitalization is closest to that of the company stock on a percentage basis. The “valuation peers” may be defined for example as the 20 stocks whose valuation metrics are as close as possible to those of the company's stock. Five valuation metrics are used: market capitalization, forecast sales growth, dividend yield, net debt-to-capital ratio, and forecast earnings to price ratio. Closeness may be measured as the sum of the percentage difference between a given stock and the company stock over the five metrics.

With the two sets of peer stocks determined, “index weightings” of the peer stocks are preferably determined. The index weightings are the fraction of holdings that a passive index portfolio would hold. For example, the 10 industry peer stocks might make up 2.5% of the S&P 500 index or some other broad-based index. Next, each portfolio is examined to compare its holdings of the peer stocks with the index weightings. If the holdings of the peer stocks are more than twice that of the index weightings, then the quant fit score is increased by 2.5. If the holdings of the peers stocks are less than half the index weights, then the quant fit score is reduced by 2.5. The process is carried out for both sets of peer stocks. Therefore, it is possible for the quant fit score to be increased by 5 points, or decreased by 5 points, on the basis of this adjustment.

For example, suppose that for a given customer's industry peer stocks, the index weights are 2.0%. The holdings of these peer stocks represent 5%, 3%, and 0.5% of the holdings of portfolios A, B, and C. In this case, the Quant Fit score for portfolio A is increased by 2.5, that of portfolio B is unchanged, and that of portfolio C is reduced by 2.5.

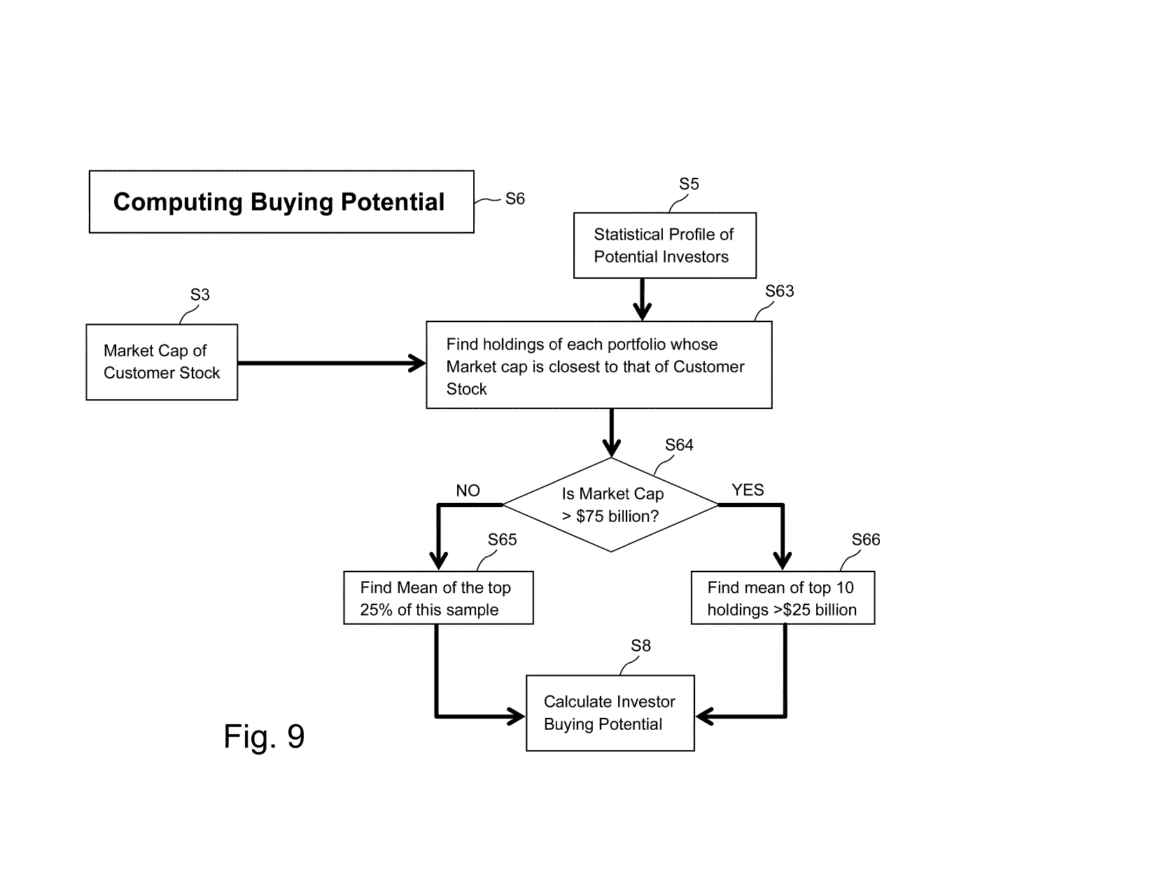

FIG. 9 is a flowchart diagram illustrating non-limiting example procedures for computing the second total impact parameter termed the “Purchasing Impact” score in the non-limiting example below. This metric quantifies the potential size of a given portfolio manager's holdings of the company's stock, given that the manager (investor) decides to hold the company's stock. The server analyzes the value of holdings of a given portfolio for stocks with market capitalization similar to that of the company's stock (step S63) as now described. Let the market capitalization of the customer stock be written MC_{cust}. For a given portfolio j, let the market capitalization of stock i be written MCᵢⱼ. The percentage difference in the market cap of the customer stock and the portfolio components is calculated as:

Pct. Diffᵢⱼ=|log(MC_{cust})−log(MCᵢⱼ)|.

The server identifies the portfolio components that are the lowest 20% in terms of percentage difference (Pct Diff). Of these, those components whose market capitalization is no more than twice the market capitalization of the company stock, or less than half that of the company stock, are retained. These stocks make up the sample from which the purchasing impact is calculated. For example, suppose a given portfolio contains 120 stocks, and the company stock has a market cap of $5 billion. The 24 stocks (=120×20%) whose market cap is closest to $5 billion, in percentage terms, are identified (using Pct Diff). Suppose that within these 24 stocks, 3 have a market cap less than $2.5 billion ($5 billion÷2), and 4 have a market cap greater than $10 billion ($5 billion×2). These 7 stocks are removed from consideration, leaving a sample of 17 stocks.

Once the sample of stocks is identified, the distribution of holdings is determined. From this distribution, the 75^{th} percentile is found, as is the maximum holding. The purchasing impact is defined as the mean of the holdings greater than or equal to the 75^{th} percentile, excluding the maximum holding. Put in other terms, the purchasing impact is the mean of the upper 25% of the holdings, excluding the maximum (step S65).

Returning to the example in which the sample was made up of 17 stocks, suppose that among these stocks, the minimum holding is $500 thousand and the maximum is $15 million. The 75^{th} percentile might be a value like $7 million. The purchasing impact would be the mean of the holdings greater than or equal to $7 million, excluding the $15 million maximum. For a sample of 17 stocks, the holdings of four stocks would be used in the calculation (the 13^{th} through the 16^{th} largest holdings). Suppose this mean were $12 million. The server's interpretation of the $12 million is as follows: if the portfolio manager is interested in buying the customer's stock, then the eventual holdings could amount to as much as $12 million. If the portfolio already holds $4 million of the company stock, then the potential for additional purchases could amount to as much as $8 million.

A number of example modifications may be employed. First, if there is an insufficient number of stocks in the upper 25% of holdings to calculate a mean, then the restriction that the market cap be greater than half, or less than twice that of the customer stock, may be removed. Second, if the market capitalization of the company stock is greater than or equal to $75 billion, (step S64), then the purchasing impact/buying potential (step S8) may be taken as the mean of the top 10 holdings of stocks with market caps greater than $25 billion (step S66). Third, if the market cap of the customer stock is less than one quarter the market cap of the smallest company in the portfolio, or larger than 4 times the market cap of the largest stock in the portfolio, then the purchasing impact may be set to zero. In other words, the company's stock is so far outside the range of the portfolio's holdings that any purchase is unlikely.

To compute an overall score, the purchasing potential is preferably normalized by dividing all values by the maximum purchasing potential observed over all funds or managers. The normalized purchasing potential is defined as:

$${PP}_{i , normalized} = \frac{{PP}_{i}}{{max}_{j} ( {PP}_{j} )}$$

The normalized purchasing potential score is a basic input for the total impact score. The actual purchasing power score is a mathematical transformation of the normalized purchasing potential:

PP Scoreₜ=(PP_{tnormalized})^{0.2}×100

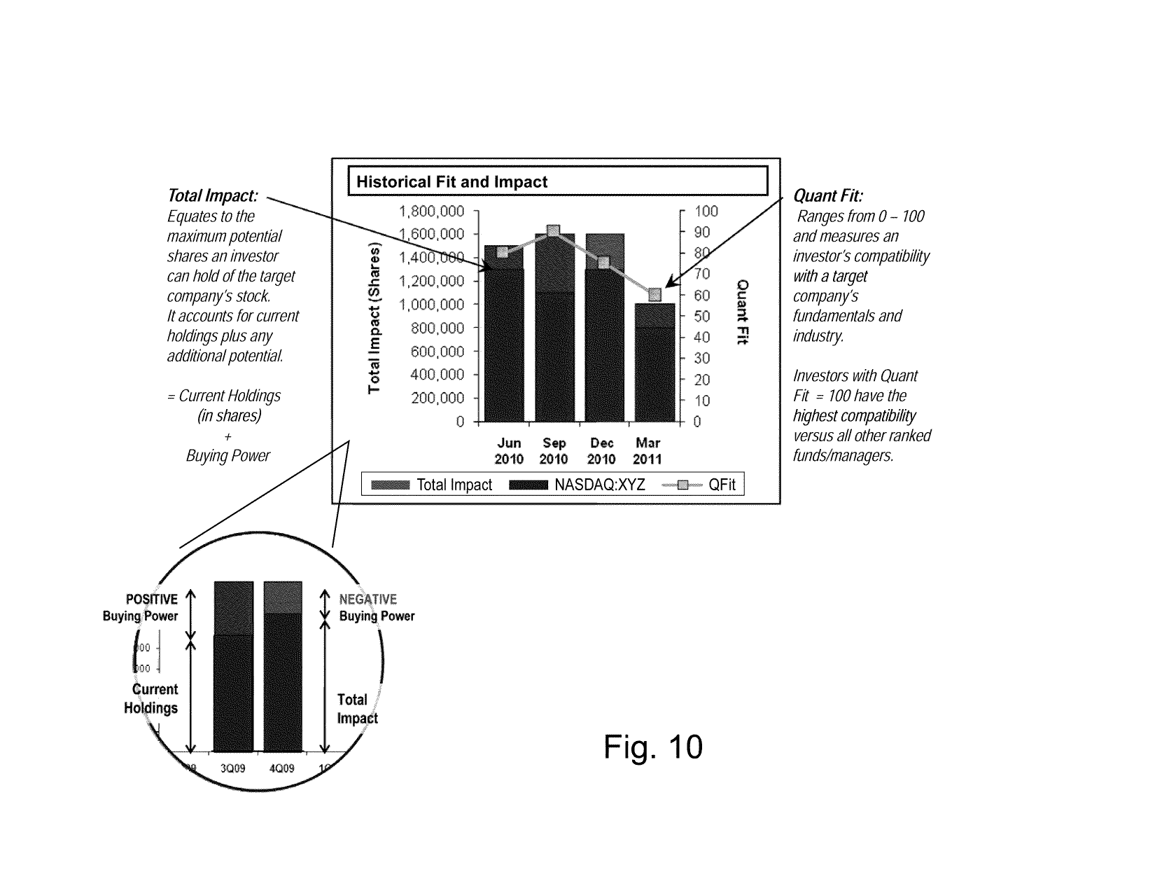

FIG. 10 show example charts illustrating the first quantitative fit (QuantFit or QFit) parameter and the second total impact parameter. The graph illustrates changes over time in investor compatibility and potential buying and/or selling power for an investor or mutual fund relative to a specific company. If the compatibility factor “Quant Fit” viewed on the right vertical axis is declining over time (as seen from the December 2011 to March 2011 period), it can be concluded that the company is not as compatible in March as it was in December. This decline in compatibility could be a potential sell indicator, as the portfolio is no longer investing in stocks like this company, or the company's fundamentals have moved outside of the primary preference of the portfolio. The opposite may concluded if the Quant Fit compatibility factor increases over time. The “Total Impact” factor (measured in shares) is depicted by the stacked bar graph relative to the left vertical axis. The bottom portion of each bar graph (black shading) indicates the current holdings, while the upper portion of each bar graph (darker grey shading) indicates an incremental buying potential. If the current holdings do not change over time, yet total impact increases, then one can conclude that the investor is allocating more assets to companies of similar size in the same global region. If the upper portion of a bar graph is shaded light grey, this indicates the current holdings are above the total impact, and as a result, the investor is deemed to hold an “overweight holding,” which is a potential sell indicator.

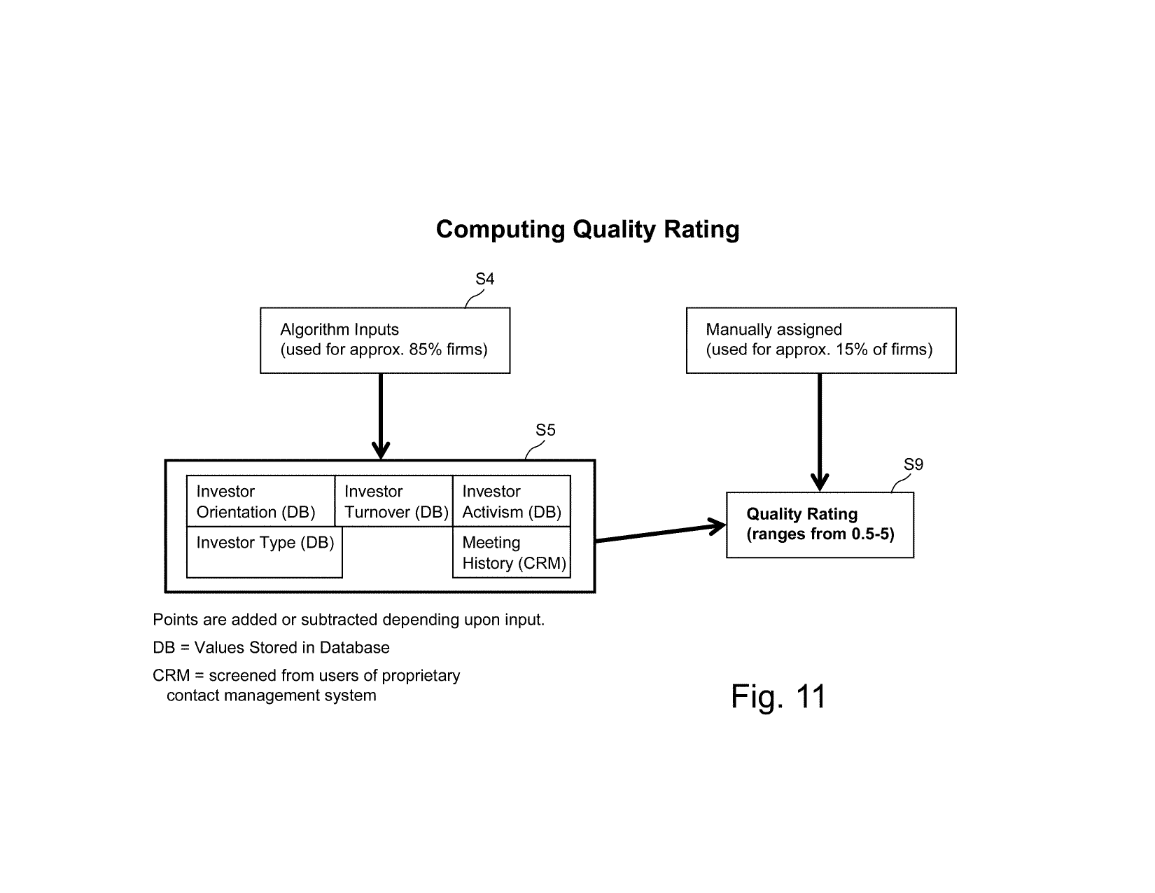

FIG. 11 is a flowchart diagram illustrating non-limiting example procedures for determining the third quality rating parameter. An institution is assigned a quality rating, which ranges in this example from 0.5-5, with 5 being the highest rating assigned. This quality rating is a “desirability rating” to help companies weed out lower quality potential investor targets (e.g., high turnover, shareholder activists, meeting agitators, or those not receptive to meeting) from higher quality investor targets. If there is not enough relevant information, a firm may be assigned a 0 or NULL rating. The quality rating may be assigned manually by one or more persons, e.g., involved with investor analytics, based on experience in tracking the trading behavior of the specific firms, receiving feedback from companies that engaged in meetings or discussions with the firms, as well as through general research. Alternatively, or in combination with, the server uses a computer-implemented algorithm to calculate a quality rating based on one or more factors such as: investor type including one of an investment advisor, a hedge fund advisor, a venture capitalist, a private investment entity, and an arbitrage manager; investment orientation including active investor, passive investor, or quantitative investor; investor turnover (low, high); shareholder activism; and meeting receptiveness (step S5). The example in FIG. 11 shows a combination of manual (15% of investors) and computer-determined (85% of investors) used to determine the quality ratings for each of the investors in the pool. Example computer-determined algorithm inputs are indicated at step S5.

In step S9, the server determines the quality rating parameter in accordance with a suitable computer algorithm. For example, if Investor Orientation=Active, then the firm starts out with a 3.5 out of 5 rating. If Investment Type=Passive or Quant, then the firm starts out with a 2.0 out of 5 rating. If Investor Type=Hedge Fund Company, Arbitrage, or Venture Capital/Private Equity, then subtract 1 from the starting score. If Investor Type=Foundation/Endowment or Private Banking Portfolio, then subtract 0.5 from the starting score. If Investor Turnover=Very High, then subtract 1 from the running score. If Investor Turnover=High, then subtract 0.5 from the running score total. If Investor Turnover=Low or Very Low, then add 0.5 to the running score total. If turnover is “Moderate” there is no turnover impact. If Turnover is blank or N/A, then a quality rating will not be assigned.

The algorithm may rely upon the third party rating systems for shareholder activism ratings. For example, a “Sharkwatch” rating system has 3 categories: “S” for Sharkwatch 50=the top 50 shareholder activists assigned by FactSet, “A”=Active Activist, and “N” for Non Active Activist. If a firm is assigned an “S”, then the server deducts 2 points from the running score; if the firm is assigned an “A”, then the server deducts 1 point from the running score. If the firm is assigned “N” or no rating is assigned, then the activism score is 0 or neutral.

Another quality rating characteristic preferably assessed by the server to determine the quality ratings for each investor in the pool is meeting receptiveness. This assessment process is performed by determining a number of meetings held by a company representative with a specific investor during a specific time period. A Contact Management System (CRM) may be used to allow users to log meetings or events with investors. The server can then use the CRM to identify from the number of events held for all companies logging meetings with each institutional investor over some time period, e.g., the prior two years. Various threshold comparison and weighting strategies may be used. For example, if more than a first predefined number of meetings with a specific investor occurred during the time period, that investor receives 1 point added to its running score total. If between the first predefined number of meetings and a second lower predefined number of meetings were held during the time period, then the investor receives 0.5 points added to its score total. If there are less than the second number of meetings, then the investor receives 0 points add to its score. If there are no meetings, then 0.5 points are subtracted from the running score total. The server preferably adjusts the final score in one non-limiting example so that the minimum score=0.5 and the maximum score=5.0.

Referring back to FIG. 3, the final single QScore assessment for each investor equally weights the “Quant Fit” and “Total Impact Score” at 40% each with the remaining 20% assigned to the Quality Rating. The resulting QScore formula=[(QF*2)+(TI Score*2)+(Quality Rating*20)/5]. The QScore in an example embodiment ranges from 0-100, where 100 is the top ranked firm based on the combination of Quant Fit, Total Impact, and Quality Rating. If there is no Quality Rating, then QScore=average of (QF+TI Score).

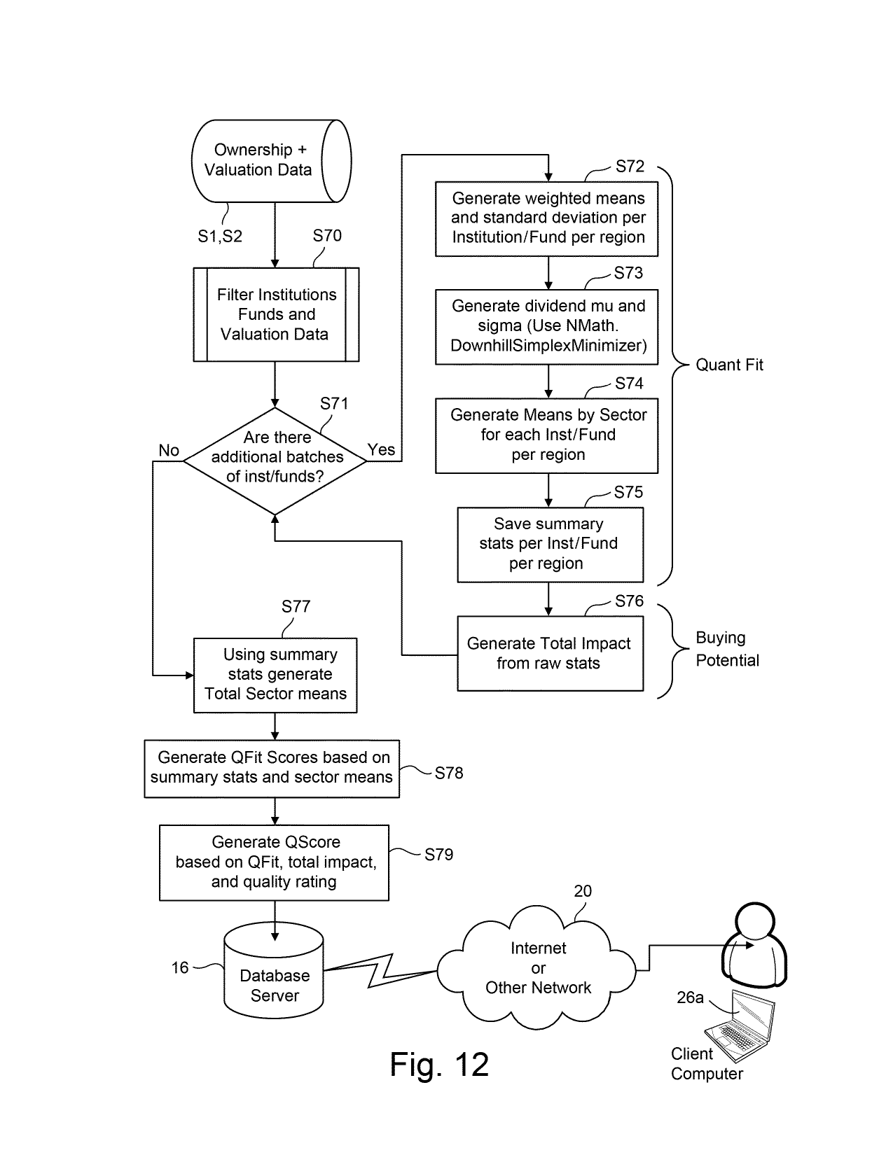

FIG. 12 is a diagram illustrating non-limiting example procedures for determining the three parameters and determining a total compatibility score for each of many investors. Ownership (holdings) and valuation data are obtained and stored in a suitable database(s) as explained above. See also S1 and S2. The investor funds and valuation metrics may be filtered (step S71), (see some of the example filterings described earlier), and if the on an investor and fund basis are analyzed on an individual basis, a decision is made in step S71 whether more batches of investors and holdings need to be processed. If there are, then steps S72-S76 are performed to determine quant fit and total impact scores for remaining investors. In this non-limiting example, the quality rating is not included but instead is updated on an as-needed basis. In step S77, summary stats are determined to calculate weighted average mean holdings of each sector for an entire sample of investors in order to calculate a relative weight for display in the “Portfolio Fit” chart. The computer server generates a QFit score for each investor based on the summary stats and sector means (step S78), and ultimately, calculates a single total score (QScore) for each investor based on its associated QFit, total impact, and quality rating (step S79). The QScore, associated QFit, total impact, and quality rating, and perhaps other metrics are stored in database or database server 16. Ultimately, this information is provided to or made accessible to client companies 26a via the internet and/or other network 20.

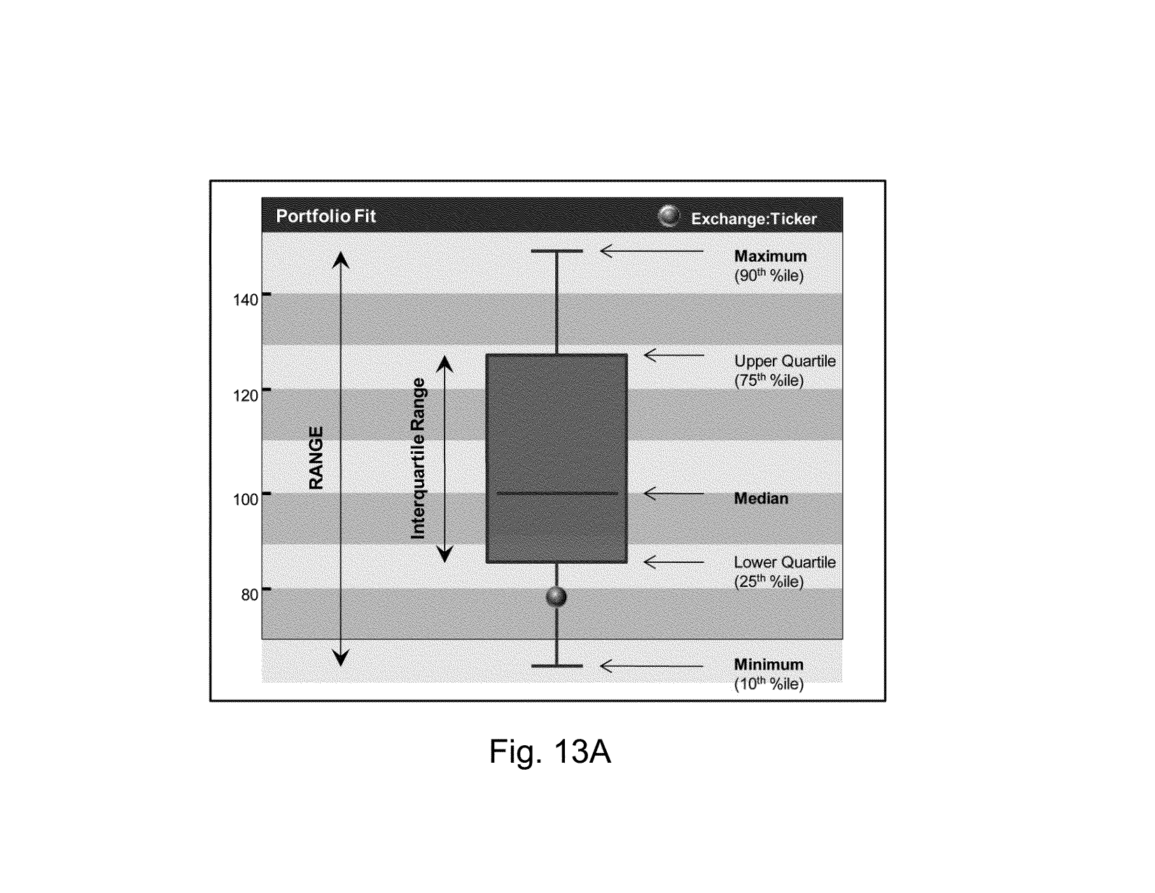

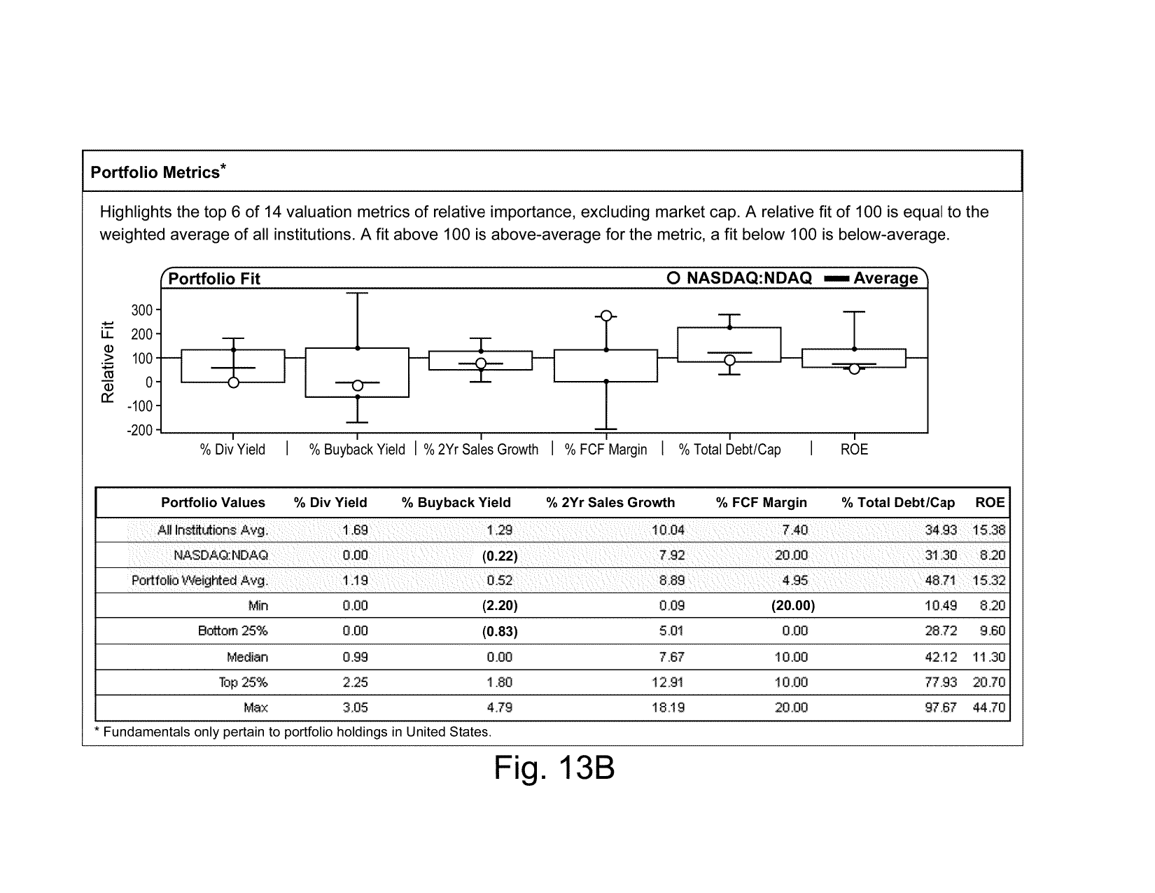

FIG. 13A is a graph showing a non-limiting example portfolio fit chart for use in illustrating how to read FIG. 13B. The portfolio fit valuation metrics are calculated based equity holdings of all analyzed investors, e.g., asset managers and mutual funds, for a most recent available period. Selection of the top six valuation metrics exhibited by the box plots shown in FIG. 13B is based on objective criteria as described below. The portfolio fit chart in FIG. 13B displays the top six of twelve metrics (excluding market capitalization) with the lowest standard deviation (variance) relative to the weighted institutional average for that specific metric. The smaller the deviation, the more selective the investor is with respect to the given metric. As such, the metrics displayed may vary by investor. The vertical axis represents an indexed scale. The base of 100 on the scale represents the weighted average metric across the investor's portfolio divided by the weighted average metric across all institutions. Points lying above and below the base represent percent deviations from the weighted average.

FIG. 13B shows a non-limiting example of how six valuation metrics of relative importance can be presented to client companies using graph and table display the six valuation metrics of relative importance for each investor on one chart with six “box-plot and whisker” displays, each of which is similar to the graph shown in FIG. 13A. The six example metrics include: Dividend Yield, Net Buyback Yield, 2 Year Forecast Sales Growth, Free Cash Flow (FCF) margin, total Debt/Capital, and Return on Equity (ROE). By displaying each metric relative to the weighted average of all investors analyzed on one display screen, the company is informed in a comprehensive but quickly absorbed way where the investor's portfolio stands relative to the average investor portfolio, as well as where the company stands relative to both the investor portfolio's preference and weighted average of all or some subset of analyzed investors. Displaying the values in this Box-Plot & Whiskers format relative to the average provides several advantages. First, one can easily depict where its company's stock (circle) fits within the overall portfolio (rectangle), whether or not it is a good fit, above or below the portfolio's preference, or an outlier. Second, by graphing the metrics relative to the institutional average allows all metrics to be displayed on one Y axis, and determine whether the portfolio has an above-average or below-average preference for a given metric. Third, by displaying the top 6 metrics by lowest relative standard deviation, one can easily identify the valuation metrics of greatest importance for that specific portfolio, which would change depending upon the portfolio being viewed.

In addition to providing a powerful, easy-to-use, single score of investor-company compatibility for each analyzed investor, the technology in this application also provides visuals that identify for the company the regions, states, countries, metro areas, etc. that are the highest priority (in terms of being the most effective areas where high compatibility investors are located) for the company to travel to in order to meet with targeted investors. Those visuals are referred to as the “roadshow planner,” which in one example embodiment integrates the results produced by the comprehensive investor assessment described above into a web-based map, produced using GOOGLE MAPS mapping technology, that displays high priority regions, states, countries, and/or metro areas for targeted company travel to meet with high compatibility investors. A company user can drill down into any of these regions to see more detail as well as view and select individual institutions as color coded icons on the map to create a “roadshow plan.” The roadshow planner allows the company user to view regional offices of targeted investors on the roadshow map. Regional offices are other locations of investors that meet one or more financial criteria, e.g., investors having $1 billion equity assets or greater that manage a minimum of $100 million of mutual fund equity assets at a location other than the one listed as its primary address. These investors may be denoted in the map display with a white icon marker and * next to the investor name.

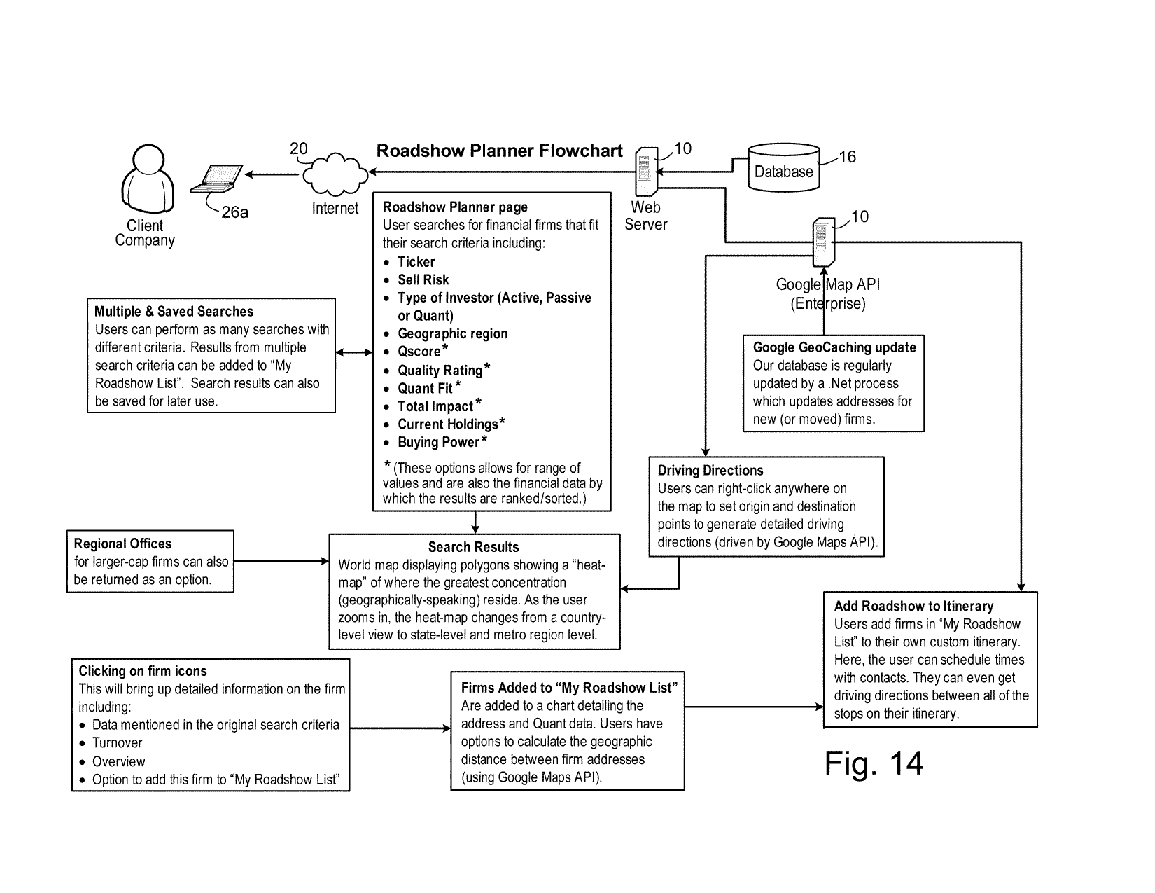

FIG. 14 is a flowchart diagram illustrating non-limiting example procedures for a graphical roadshow planner mapping tool that may be used to develop a roadshow itinerary based on the various compatibility criteria for various investors having total compatibility scores described above. As shown at the top of the figure, a company user (client company) communicates with a client computing device 26a via the interne to a web-based server 10 that communicates with one or more databases 16 as shown for example in FIG. 1. The web server also communicates with a GOOGLE MAP applications programming interface (API) server, which in this example embodiment is one of the computer servers 10.

As indicated in the Multiple & Saved Searches process block, users can perform as many investor targeting searches with different criteria for a pool of potential investors. Results from multiple search criteria can be added to “My Roadshow List” generated for the company user. Search results can also be saved for later use. The web server 10 generates a Roadshow Planner web page for the user based on the user searches for financial firms that fit their search criteria including: Ticker, Sell Risk, Type of Investor (Active, Passive or Quant), Geographic region, QScore*, Quality Rating*, Quant Fit*, Total Impact*, Current Holdings*, and Buying Power*. Asterisk * options allow for a range of values and are also the financial data by which the results may be ranked/sorted. Regional offices for larger investors can also be returned as an option.

In the Search Results process block, the server generates a display for the client company a map, e.g., a world, country, region, etc. map, displaying polygons in the context of a “heat-map” that show where a greater or greatest concentration (geographically-speaking) of highly compatible investors reside. As the user zooms in, the server 10 changes the heat-map from a higher level view, e.g., a country-level, to a lower level view, e.g., state-level and metro region level.

In response to the user clicking on an investor (e.g., firm) icon displayed on the map, the server 10 displays detailed information on the investor including one or more of: data mentioned in the original search criteria, turnover, overview, an option to add this investor to “My Roadshow List.” Firms are added to “My Roadshow List” via a chart detailing the investor's address and corresponding quant data. A company user has an option to calculate the geographic distance between firm addresses using the GOOGLE MAPS API.

The Google GeoCaching update process block indicates that the database 16 is regularly updated by a .Net process which updates addresses for new (or moved) investors.

The Driving Directions process block allows a user to right-click anywhere on the map to set origin and destination points to generate detailed driving directions using the GOOGLE MAPS API.

The Add Roadshow to Itinerary process block allows a user to add investors in “My Roadshow List” to their own custom itinerary. Here, the user can schedule times with contacts. They can even get driving directions between all of the stops on their itinerary.

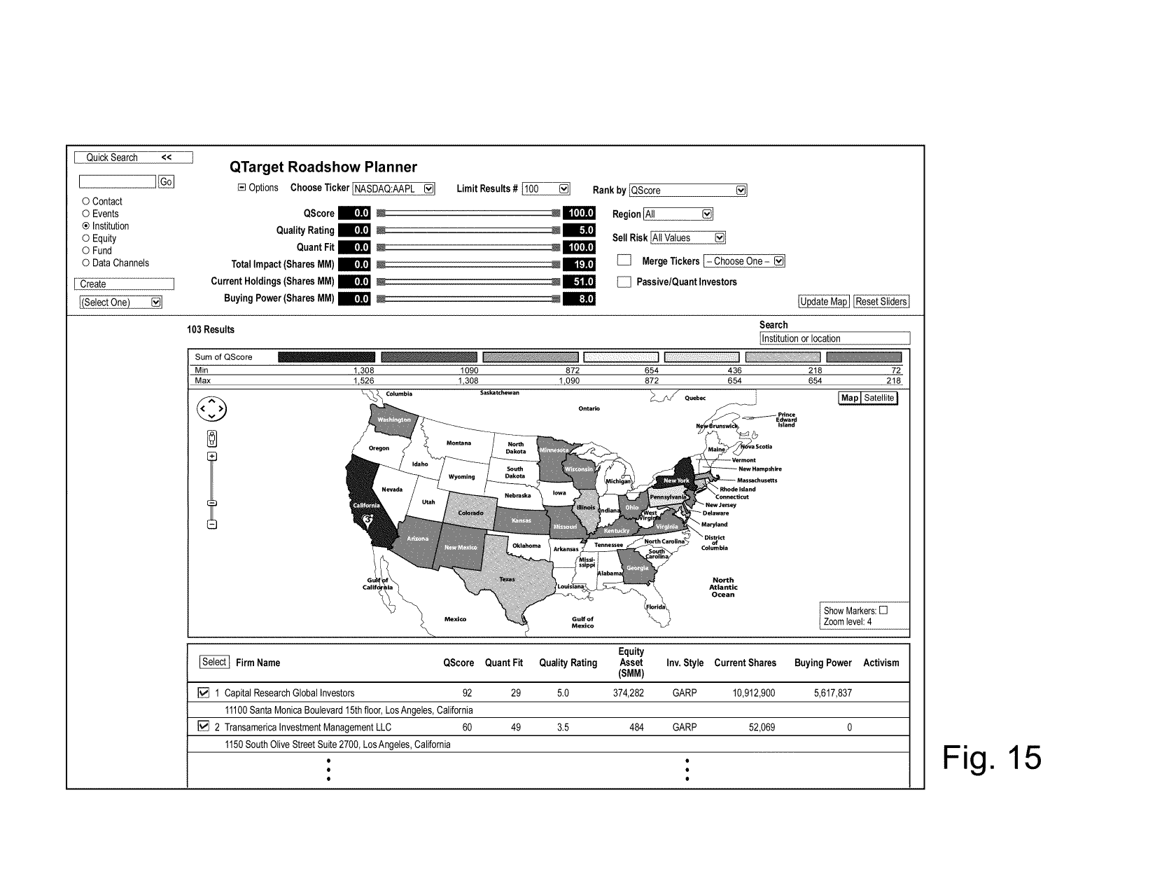

FIGS. 15-22 are non-limiting example graphical mapping screenshots relating to the road show itinerary planning. FIG. 15 shows an example where an interactive, map-based Roadshow Planner is integrated with quantitative and qualitative scores to identify key regions with the greatest investor impact to facilitate outreach efforts. The Roadshow Planner is also integrated in this example with an itinerary functionality that seamlessly connects the roadshow planning with meeting coordination.

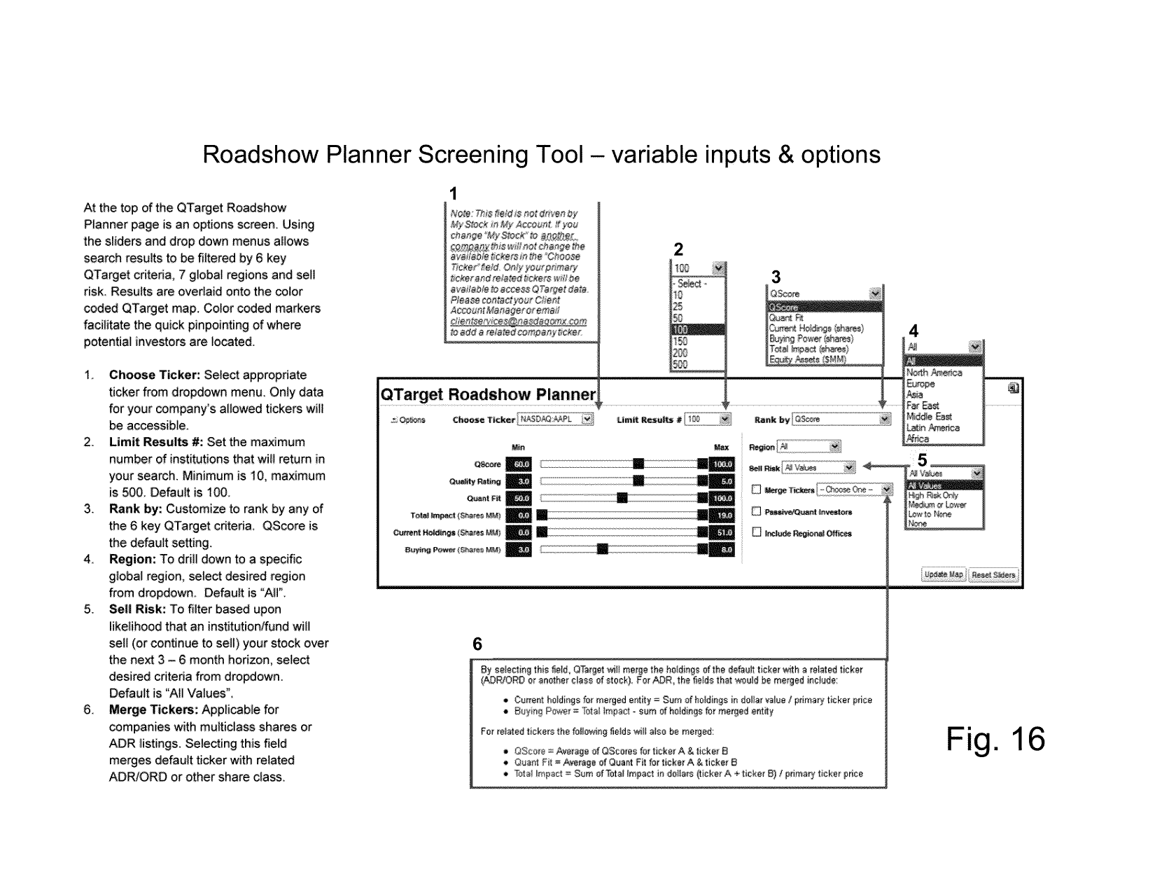

As shown in FIG. 16, at the top of the QTarget Roadshow Planner page is an options screen. Using sliders and drop down menus allows search results to be filtered in this non-limiting example by six valuation metrics or criteria, seven global regions, and a sell risk parameter. Sell risk indicates a likelihood that an investor will sell (or continue to sell) a position over a particular time period, e.g., a three-to-six-month time horizon. Results are overlaid onto the color coded map. Color coded markers facilitate the quick pinpointing of where potential target investors are located. The user may perform the following steps: Step 1 is Choose Ticker: Select appropriate ticker from dropdown menu. Step 2 is Limit Results #: Set the maximum number of institutions that will return in your search. Step 3 is Rank by: Customize to rank by any of the 6 key QTarget criteria. Step 4 is Region: To drill down to a specific global region, select desired region from dropdown. Step 5 is Sell Risk: To filter based upon likelihood that an institution/fund will sell (or continue to sell) your stock over the next 3-6 month horizon, select desired criteria from dropdown.

Step 6 is Merge Tickers: Applicable for companies with multiclass shares or ADR listings. Selecting this field merges default ticker with related ADR/ORD or other share class.
Step 7 is Passive/Quant Investors: Selecting this includes Passive/Quant oriented managers.
Step 8 is Include Regional Offices: Regional offices are not automatically displayed. Selecting this will include branch locations of institutions that meet selected screening criteria.
Step 9 is Adjusting the Min/Max Sliders: To filter based upon QTarget key criteria, drag the minimum and maximum sliders to desired threshold levels. As the sliders are moved along the value bar, the value in the grey box on either side of the slider bar will change to reflect the current range value.

When all desired options have been selected, the user clicks the “Update Map” button to view results on the map. The Excel icon is used to download all search results. To restart the process completely, click the “Reset Sliders” button. Once the map has updated, the user clicks on the map itself or uses a zoom feature to focus in on particular regions and ultimately identify potential investors.

Regions are broken down into 7 different color-coded categories identified in the heat map legend, based on the sum of the “Rank by” field. For example, if the user ranks by “QScore”, the maximum value will be the region with the highest aggregate QScores. This makes it easy to visually identify regions with the highest concentration. At a certain zoom level, icons representing specific institutions will appear on the map. The user can select the box for “Show Markers” to view the geographic location of investors at a lower zoom level. Like the map, the icons are preferably color coded based on the color scale displayed in the legend to make it easier to visually identify investors with the highest value. For example, the redder the icon the greater the value. Markers denoting regional offices can be coded with a different color, e.g., white.

Clicking on an investor icon opens a window containing summary information and data along with an overview of the institution to help qualify a potential investor. Regional offices are denoted by an asterisk to the left of the investor name. To view more detailed information, the user can click an expand symbol left of the “Overview” label.

To aid with meeting planning, a user can use an “Add to Roadshow” link on an investor summary pop-up. This process may be repeated for desired investors and added to the results list below the map in the order selected. To search for a particular firm or location, begin typing the name in the Search bar. The following non-limiting example data fields preferably appear along with the investor name and address: QScore, Quant Fit, Quality Rating, Equity Assets, Investor Style, Current Shares, Buying Power, and Activism. Once desired institutions are selected, click Add to Itinerary to be taken to a calendar into which events can easily be added. An “Add to Itinerary” display button may be used to integrate selected results with itinerary planning functionality, thus connecting roadshow planning with meeting scheduling and coordination.

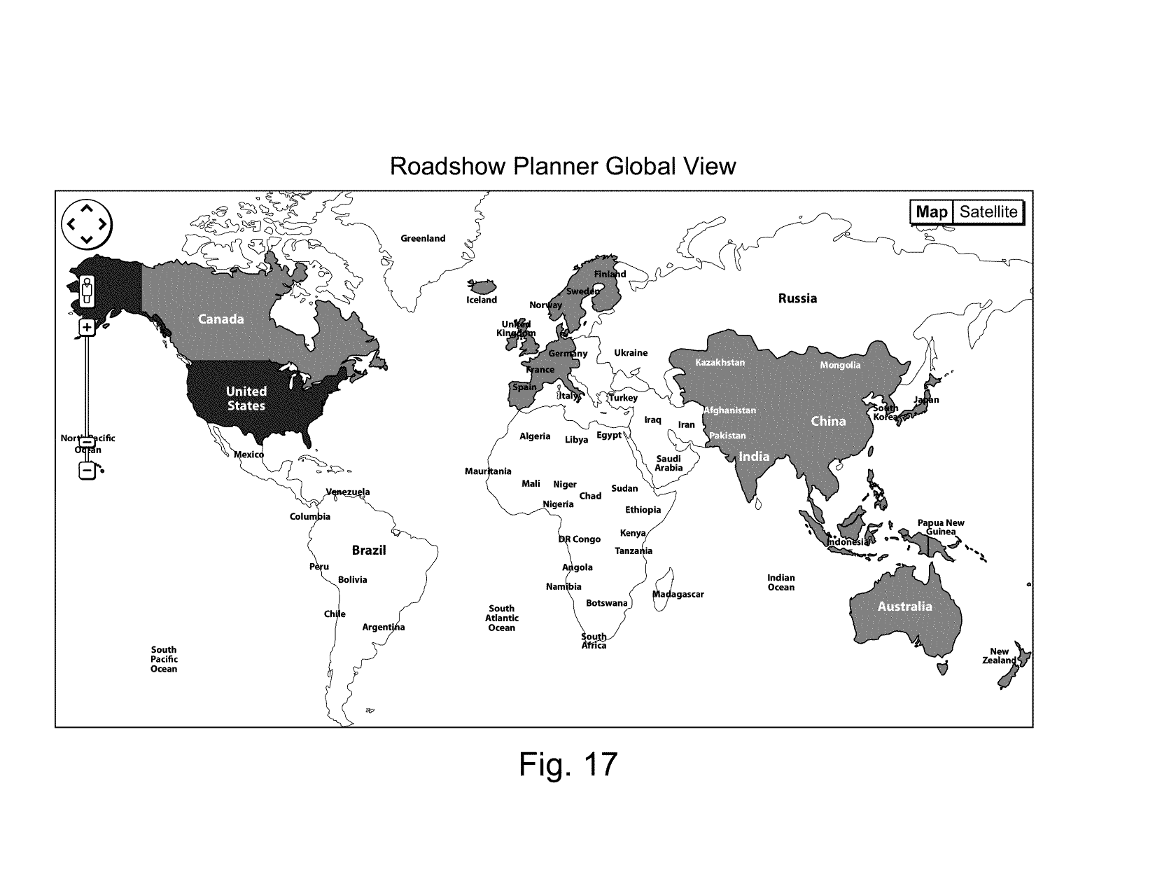

FIG. 17 displays an example of results of screening for the top 100 investors by QScore, at the “global” view of the world, with each region color (shown as shading in the figure) coded by the sum of total investors QScore in each region. The user can zoom into a region, e.g., by moving the zoom bar + or − displayed on the left of the screen, by clicking on a point on the map, or by using a mouse scroll wheel.

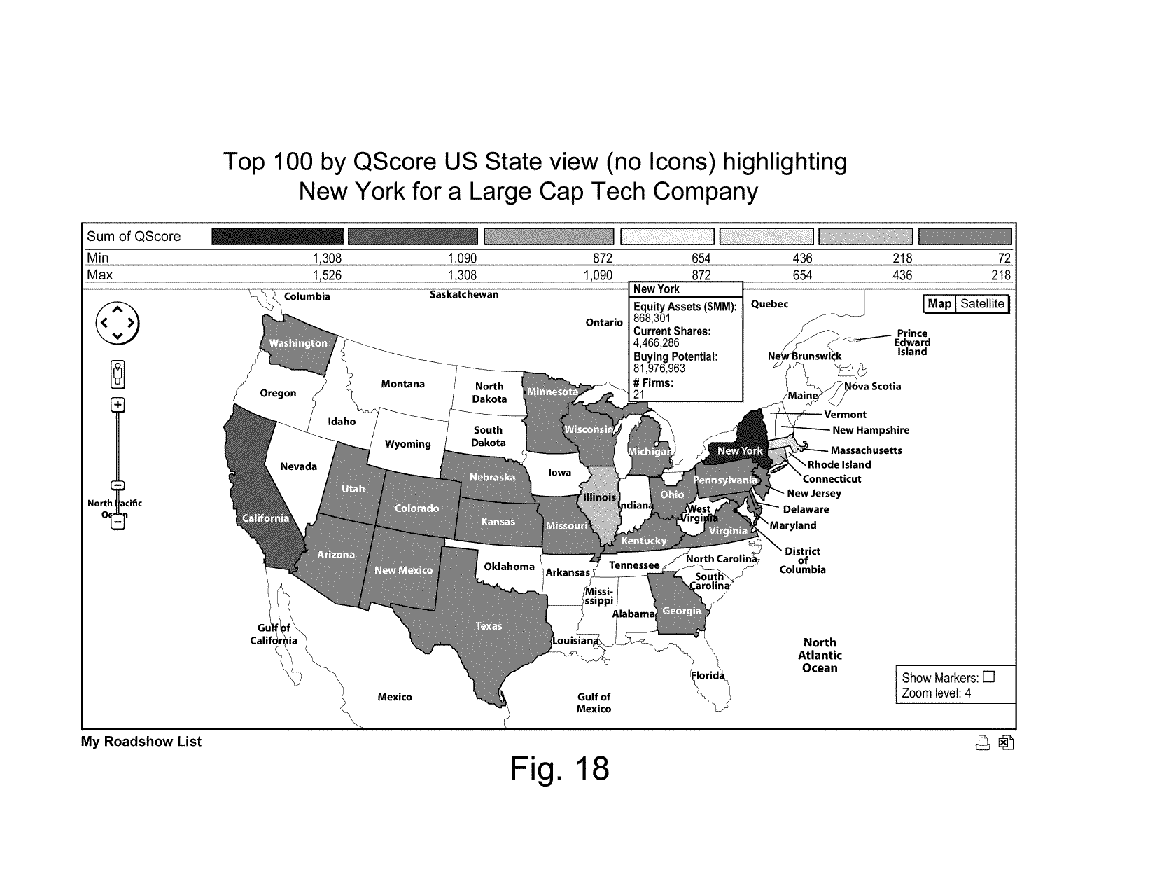

FIG. 18 displays the results of screening for the top 100 investors by QScore, drilling down to a State level view of the United States, e.g., by clicking into the United States map in FIG. 17. Each region is color-coded (shown as shading in the figure) based on a “heat map” sum of QScores broken into seven (7) equal segments, with the darker color (shown as darker shading in the figure) containing the States with the highest total QScore. The cursor is highlighted over New York in this example, and as a result, a pop-up summary of the region is displayed. Hovering over a different State causes display of a summary tailored to that location.

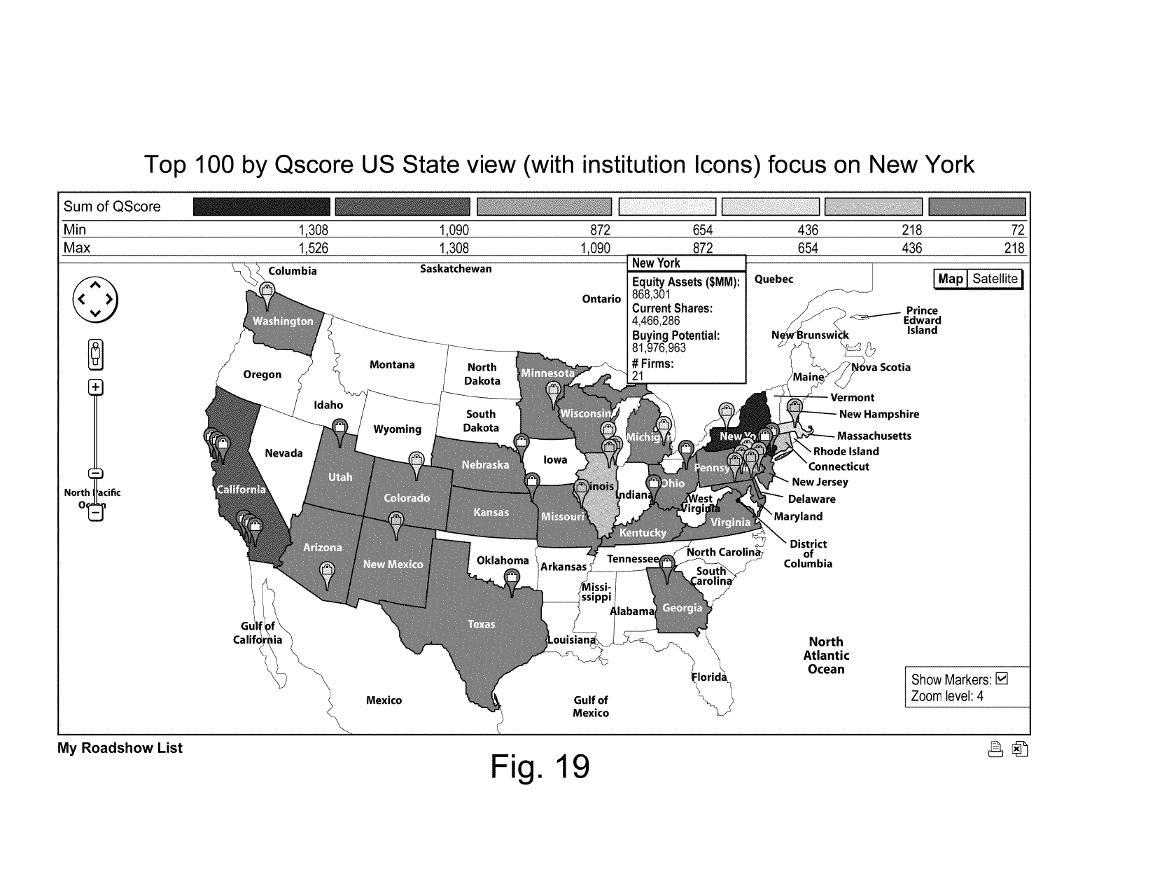

FIG. 19 is a similar view as FIG. 18 with the addition of “Show Markers” (bottom right) checked off to display investor institutions as markers on the map based on their latitude/longitude locations as determined by the primary address (or other address, if including regional offices) in the database 16.

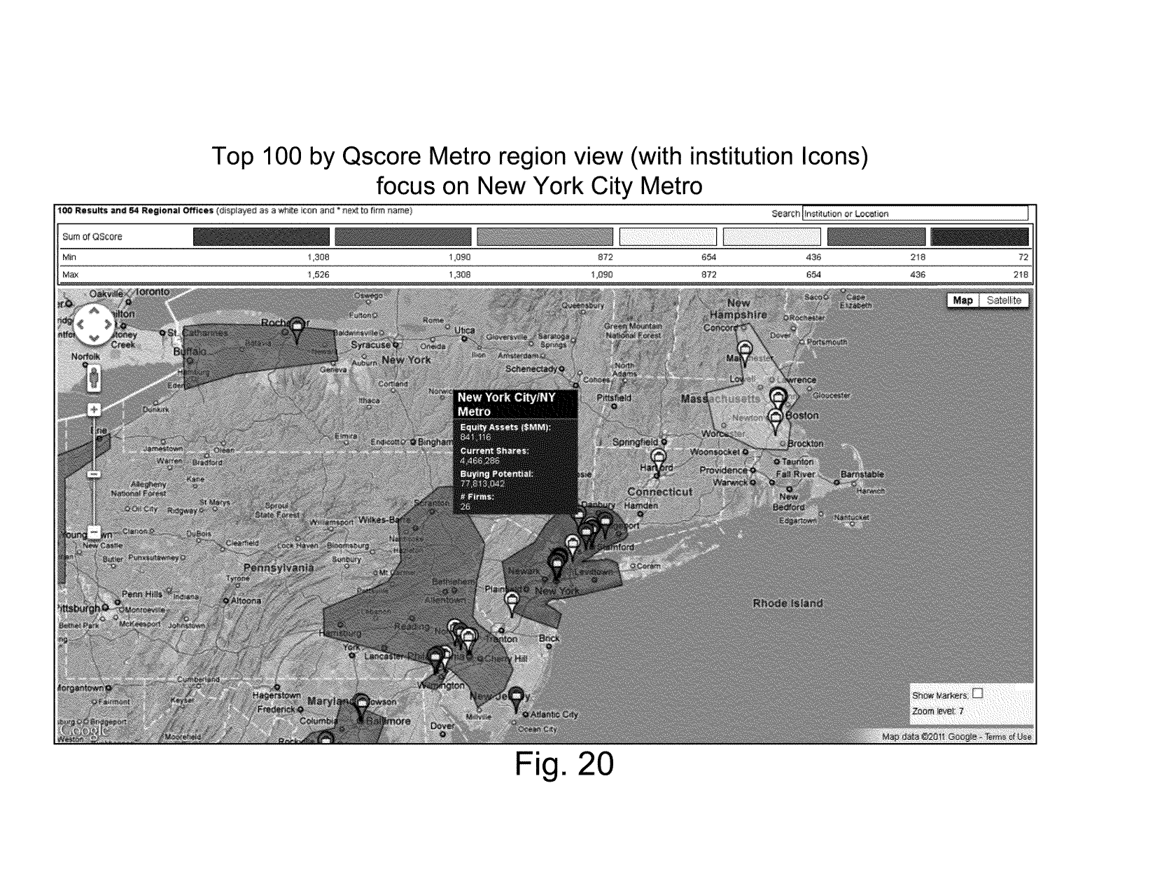

FIG. 20 displays an example of the top 100 results by QScore in the Northeast United States at the “Metro Region” level. Many metro regions are preferably drawn and stored in the database 16 based on latitude/longitude coordinates to depict metro regions (like New York) that may contain more than one city. If a company representative is looking to meet with investors in a given location, then that company representative may also want to travel 30-50 miles to another nearby city to meet with other investors on the same or next day. This option is presented using the “Metro Region” feature. Each investor is depicted with an icon on the map and appears at various zoom levels. The institution icons are also preferably color-coded based on “heat map” colors to easily identify the investors with the highest QScore, or other category chosen in the “Rank By” drop down field (#3 in FIG. 16).

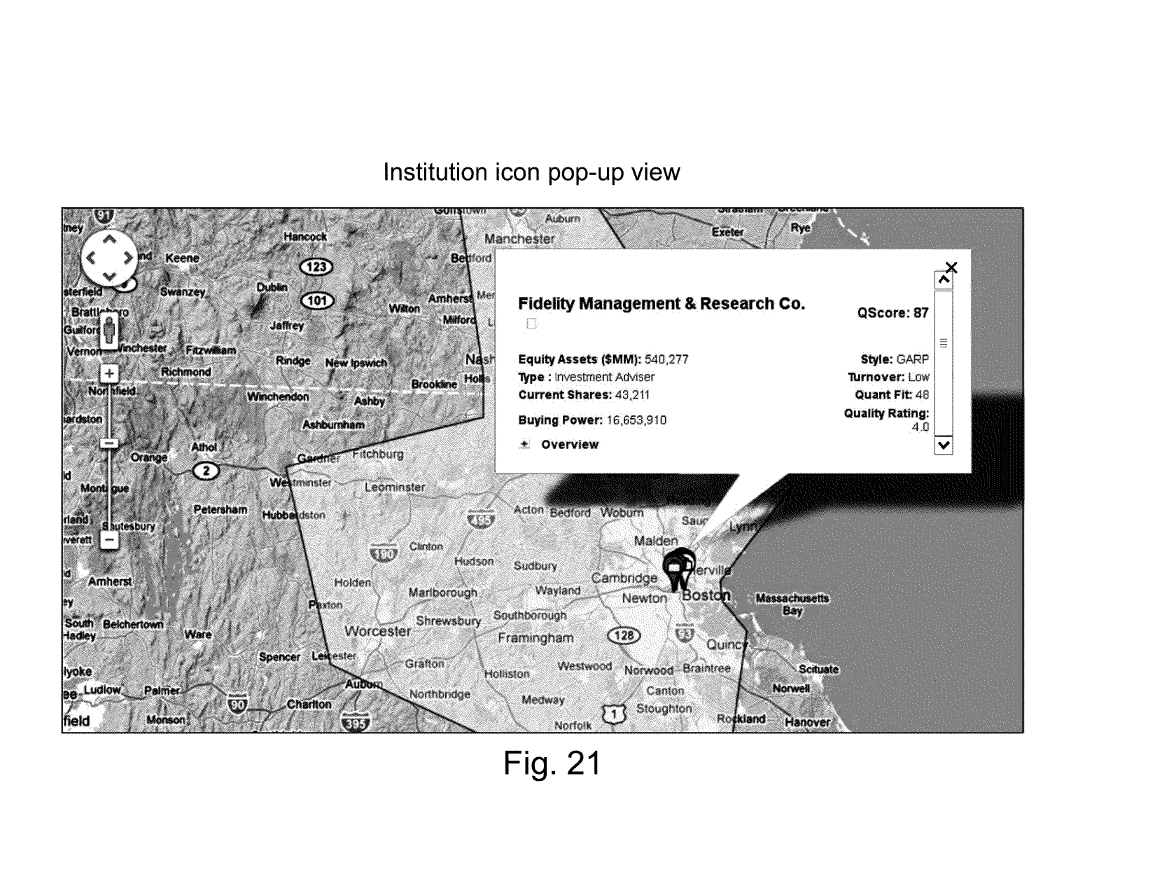

FIG. 21 depicts a Metro Region view (Boston), highlighting the institution pop-up icon that appears when clicking on an investor institution. The icon displays various details about the investor that enables a company representative to determine whether or not this is a suitable investor meeting candidate. Example data shown includes: QScore, Investor Activism icon, Equity Assets, Investor Style, Investor Type, Investor Turnover, Current Shares Held, Quant Fit Score, Buying Power (Shares), Quality Rating, and an overview, which can be read in this example by clicking the “+Overview.” Clicking “Add to Roadshow” above the investor name adds the firm into “My Roadshow List,” an example of which is now described.

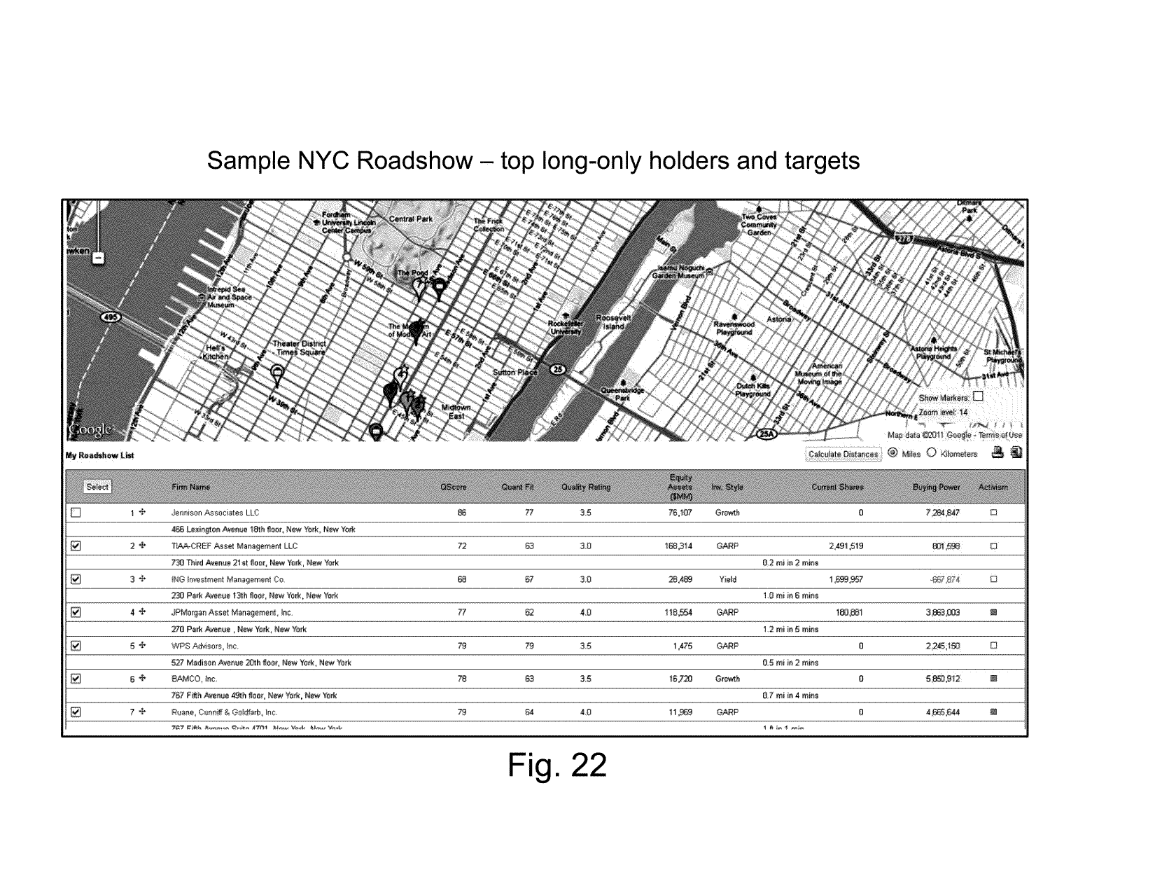

In the example “My Roadshow List” shown in FIG. 22, users can check or uncheck firms to Save or “Add to Itinerary,” compare overall scores, buying potential or other firm characteristics, as well as calculate distances from the first investor name to the second, and so forth. After calculating distances, if there is a more optimal meeting order, the user can drag and drop each firm into a different order, optimizing travel time. The user can also download all results or “My Roadshow List” to an Excel application, e.g., a spreadsheet.

The technology described in this application includes many technical advantages, some of which are now described. The single compatibility score generated by the computer server(s) readily identifies top investor targets based on at least three criteria: quantitative fit, buying power or impact, and investor quality. Both quantitative and qualitative investor characteristics are included in the final compatibility score. Adding a qualitative component to the overall investor compatibility assessment provides another level of insight to help companies prioritize and make more effective their communication with investors. Previously, companies had to rely on an investor relations expert or consultant with knowledge of an institutional investor's trading history and insight into the firm's desirability as an investor. In addition, the technology provides transparency so that the company can understand the reasoning behind a high or low compatibility score for a particular investor. For example, by displaying each portfolio metric relative to a weighted average of all investors, all metrics can be displayed on one chart to depict where a specific investor's portfolio stands relative to an average investor as well as where the company stands relative to both the investor portfolio's preference and weighted average of all investors. Another advantageous feature is the visualization tool that identifies geographical locations, regions, states, countries, metro areas, etc. having the highest priority for a company to travel to meet with high scoring investors. Another advantageous feature is utilizing standard deviation in the Quant Fit calculation. By using the standard deviation, the model weights the relative importance of each metric for each specific fund or institution. As a result, a weighting for a specific metric need not be assigned. Instead, the data itself informs which factors of the factors analyzed are most important for that investor. Furthermore, transforming the quantitative fit algorithm for certain metrics assures symmetry in the distribution, thereby providing a more statistically sound model. An example Roadshow Planner advantage includes the option for a company representative to view “Regional Offices” on the Roadshow Planner map, which ensures that the company representative does not miss investors that manage significant assets in a location other than its primary address. As a result, the Roadshow Planner provide more detailed investor location data at the fund level than was previously available.

Although various embodiments have been shown and described in detail, the claims are not limited to any particular embodiment or example. None of the above description should be read as implying that a particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

1. A computer-implemented method for targeting potential investors for a company, comprising:
obtaining, by a computer server, investment characteristics information associated with each of a first number of investors;
determining, by the computer server, asset characteristics information associated with the company interested in attracting investment;
analyzing, by the computer server, the investment characteristics information associated with each of the first number of investors and the asset characteristics information associated with the company,
wherein the analyzing step includes determining a total compatibility score for each of the first number of investors that is based on:
a first quantitative fit parameter reflecting a degree of compatibility between the investment characteristics information associated with each of the first number of investors with the asset characteristics information associated with the company that is based on quantitative metrics,
a second total impact parameter reflecting a monetary investment potential in the company for each of the first number of investors, and
a third quality rating parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history;
identifying a second smaller number of investors from the first number of investors based on the total compatibility scores;
providing the second smaller number of investors to the company for prioritized investment targeting efforts on investors having higher respective total compatibility scores.

2. The computer-implemented method of claim 1, wherein the first quantitative fit parameter is determined based on both a mean deviation and a standard deviation of each of multiple investor holding valuation metrics for a portfolio of holdings associated with each investor.

3. The computer-implemented method of claim 2, wherein the standard deviation is complemented with a relative importance metric of each investor holding valuation metric for each of the first number of investors.

4. The computer-implemented method of claim 2, wherein one of the investor holding valuation metrics is dividend yield, the method further comprising converting the dividend yield modeled as a truncated symmetric statistical distribution to a non-truncated symmetric statistical distribution.

5. The computer-implemented method of claim 4, wherein one of the investor holding valuation metrics is a sector-based holding valuation metric, the method further comprising modeling each sector-based holding as a multinomial distribution.

6. The computer-implemented method of claim 5, wherein the analyzing step includes calculating a statistical profile for each of the first number of investors based on the mean deviation and the standard deviation of the multiple investor holding valuation metrics associated with each investor, the dividend yield modeled as a truncated symmetric statistical distribution metric, and sector-based holdings each modeled as a multinomial distribution.

7. The computer-implemented method of claim 6, the method further comprising transforming the truncated symmetric statistical distribution metric into a statistically symmetric distribution metric.

8. The computer-implemented method of claim 2, wherein the investor holding valuation metrics for a portfolio of holdings associated with each investor includes one or more of the following factors: market capitalization, dividend yield, price to book value, forecast 2-year sales growth, forecast price to earnings ratio, forecast enterprise value (EV)/earnings before interest, taxes, depreciation, and amortization (EBITDA), return on equity (ROE), market beta, net debt/total capital, forecast long-term earnings growth, free cash flow yield, net buyback yield, and sector/industry.

9. The computer-implemented method of claim 1, wherein the analyzing step includes determining the total compatibility score for each of the first number of investors using one or both of (1) a buying assessment based on a current amount of investment in the company by each of the investors and an amount that each investor has available for purchase in the company in addition to what that investor may already own or (2) a selling assessment assessing an amount that each investor is over-weighted in investment in the company as compared to an estimated fully-weighted investment in the company.

10. The computer-implemented method of claim 1, wherein the third quality rating parameter is also based on one or more of the following additional investor attributes:
an investment type including one of an investment advisor, a hedge fund advisor, a venture capitalist, a private investment entity, and an arbitrage manager;
an investment orientation including active investor, passive investor, or quantitative investor; and
investment turnover.

11. The computer-implemented method of claim 1, further comprising selectively weighting each of the first, second, and third parameters and combining the weighted parameters to generate the total compatibility score for each of the first number of investors.

12. The computer-implemented method of claim 1, wherein:
the investment characteristics information includes current investment holdings in each investor's investment portfolio and is obtained from public disclosures made by each investor;
the obtaining step includes filtering the current investment holdings in each investor's investment portfolio investment characteristics information associated with each of a first number of investors, and
the determining step includes transforming holding valuation metrics to a symmetric statistical distribution.

13. (canceled)

14. The computer-implemented method of claim 1, wherein the step of providing the second number of investors to the company includes providing a display map of geographic regions associated with the second number of investors having higher respective total compatibility scores assisting a company representative in travel planning for face-to-face meetings with each of the second number of investors.

15. The computer-implemented method of claim 14, wherein the display map of geographic regions in which display map a viewer selects and highlights individual investor locations creating a travel plan for the company representative to visit the higher priority investors having higher respective total compatibility scores.

16. The computer-implemented method of claim 15, wherein the display map of geographic regions in which display map the viewer selects and highlights individual investor locations having a predetermined minimum amount of holding assets.

17. A computer server for targeting potential investors for a company, comprising:
a memory configured to store investment characteristics information associated with each of a first number of investors and asset characteristics information associated with a company interested in attracting investment;
processing circuitry, capable of communicating with the memory, configured to analyze the investment characteristics information associated with each of the first number of investors and the asset characteristics information associated with the company,
wherein the processing circuitry is configured to determine a total compatibility score for each of the first number of investors that is based on:
a first quantitative fit parameter reflecting a degree of compatibility between the investment characteristics information associated with each of the first number of investors with the asset characteristics information associated with the company that is based on quantitative metrics,
a second total impact parameter reflecting a monetary investment potential in the company for each of the first number of investors, and
a third quality rating parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history; and
wherein the processing circuitry is configured to identify a second smaller number of investors from the first number of investors based on the total compatibility scores and provide the second smaller number of investors to the company for prioritized investment targeting efforts on investors having higher respective total compatibility scores.

18. The computer server in claim 17, wherein the processing circuitry is configured to determine the first quantitative fit parameter based on both a mean deviation and a standard deviation of each of multiple investor holding valuation metrics for a portfolio of holdings associated with each investor.

19. The computer server of claim 18, wherein the standard deviation also weights a relative importance of each investor holding valuation metric for each of the first number of investors.

20. The computer server of claim 18, wherein one of the investor holding valuation metrics is dividend yield, and wherein the processing circuitry is configured to convert the dividend yield modeled as a truncated symmetric statistical distribution to a non-truncated symmetric statistical distribution.

21. The computer server of claim 20, wherein one of the investor holding valuation metrics is a sector-based holding valuation metric, and wherein the processing circuitry is configured to model each sector-based holding as a multinomial distribution.

22. The computer server of claim 21, wherein the processing circuitry is configured to calculate a statistical profile for each of the first number of investors based on the mean deviation and the standard deviation of the multiple investor holding valuation metrics associated with each investor, the dividend yield modeled as a truncated symmetric statistical distribution metric, and sector-based holdings each modeled as a multinomial distribution.

23. The computer server of claim 22, wherein the processing circuitry is configured to transform the truncated symmetric statistical distribution metric into a statistically symmetric distribution metric.

24. The computer server of claim 18, wherein the investor holding valuation metrics for a portfolio of holdings associated with each investor include one or more of the following factors: market capitalization, dividend yield, price to book value, forecast 2-year sales growth, forecast price to earnings ratio, forecast enterprise value (EV)/earnings before interest, taxes, depreciation, and amortization (EBITDA), return on equity (ROE), market beta, net debt/total capital, forecast long-term earnings growth, free cash flow yield, net buyback yield, and sector/industry.

25. The computer server of claim 17, wherein the processing circuitry is configured to determine the total compatibility score for each of the first number of investors using one or both of (1) a buying assessment based on a current amount of investment in the company by each of the investors and an amount that each investor has available for purchase in the company in addition to what that investor may already own or (2) a selling assessment assessing an amount that each investor is over-weighted in investment in the company as compared to an estimated fully-weighted investment in the company.

26. The computer server of claim 17, wherein the third quality rating parameter is also based on one or more of the following additional investor attributes:
an investment type including one of an investment advisor, a hedge fund advisor, a venture capitalist, a private investment entity, and an arbitrage manager;
an investment orientation including active investor, passive investor, or quantitative investor; and
investment turnover.

27. The computer server of claim 17, wherein the processing circuitry is configured to selectively weight each of the first, second, and third parameters and combine the weighted parameters to generate the total compatibility score for each of the first number of investors.

28. The computer server of claim 17, wherein the investment characteristics information includes current investment holdings in each investor's investment portfolio and is obtained from public disclosures made by each investor, and
wherein the processing circuitry is configured to:
filter the current investment holdings in each investor's investment portfolio investment characteristics information associated with each of a first number of investors, and
transform holding valuation metrics to exhibit a symmetric statistical distribution.

29. The computer server of claim 17, wherein the processing circuitry is configured to provide a display of multiple valuation metrics for each of the second number of investors in a single chart relative to the weighted average of all of the first number of investors.

30. The computer server of claim 17, wherein the processing circuitry is configured to provide a display map of geographic regions associated with the second number of investors having higher respective total compatibility scores assisting a company representative in travel planning for face-to-face meetings with each of the second number of investors.

31. The computer server of claim 30, wherein the display is configured to map of geographic regions in which display map a viewer selects and highlights individual investor locations creating a travel plan for the company representative to visit the higher priority investors having higher respective total compatibility scores.

32. The computer server of claim 31, wherein the display is configured to map of geographic regions in which display map a viewer selects and highlights individual investor locations having a predetermined minimum amount of holding assets.

33. A non-transitory computer-readable medium storing computer instructions, which when executed by a computer, cause the computer to implement the following tasks for use in targeting potential investors for a company, comprising:
obtain investment characteristics information associated with each of a first number of investors;
determine asset characteristics information associated with a company interested in attracting investment;
analyze, by the computer, the investment characteristics information associated with each of the first number of investors and the asset characteristics information associated with the company,
wherein the analysis includes determining a total compatibility score for each of the first number of investors that is based on:
a first quantitative fit parameter reflecting a degree of compatibility between the investment characteristics information associated with each of the first number of investors with the asset characteristics information associated with the company that is based on quantitative metrics,
a second total impact parameter reflecting a monetary investment potential in the company for each of the first number of investors, and
a third quality rating parameter for each of the first number of investors reflecting a desirability of targeting the investor as a meeting candidate or shareholder based on one or more of the following investor attributes: investment time horizon for the investor, receptiveness of the investor to meeting with a representative of the company to discuss a potential investment in the company, and investor activism history;
identify a second smaller number of investors from the first number of investors based on the total compatibility scores;
provide the second smaller number of investors for the company to prioritize investment targeting efforts on investors having higher respective total compatibility scores.
